(19) United States
(12) Patent Application Publication
(10) Pub. No.: US 2026/0369024 A1
(43) Pub. Date: Nov. 19, 2026

(54) DYNAMIC AUDIO-VIDEO TRACKING AND/OR FENCING FOR VIDEO ENVIRONMENTS

(71) Applicant: Shure Acquisition Holdings, Inc., Niles, IL (US)

(72) Inventors: Daniel Law, Glencoe, IL (US); Bijal Joshi, Elk Grove Village, IL (US); Nathan Seitz, Austin, TX (US)

(21) Appl. No.: 19/675,991

(22) Filed: May 13, 2026

Related U.S. Application Data
(60) Provisional application No. 63/804,881, filed on May 13, 2025.

(51) Int. Cl. G06V 10/25; G06T 7/70; G06V 40/16; G06V 40/20

(52) U.S. Cl. CPC G06V 10/25; G06T 7/70; G06V 40/172; G06V 40/20

(57) ABSTRACT

Techniques are disclosed herein for providing dynamic audio-video tracking and/or fencing for video environments. Examples may include receiving audio data associated with an audio stream captured by at least one audio capture device associated with an environment, receiving video data associated with a video stream captured by at least one video capture device associated with the environment, determining a region of interest associated with the environment, inputting the audio data and the video data to a source tracking model to generate source tracking data for a source of interest within the region of interest, and outputting the source tracking data to an output device.

### CROSS REFERENCE TO RELATED APPLICATIONS

This application claims the benefit of U.S. Provisional Patent Application No. 63/804,881, titled “DYNAMIC AUDIO-VIDEO TRACKING AND/OR FENCING FOR VIDEO ENVIRONMENTS,” and filed on May 13, 2025, the entirety of which is hereby incorporated by reference.

### TECHNICAL FIELD

Embodiments of the present disclosure relate generally to audio and video processing and, more particularly, to systems configured for processing audio and video to enable audio-video tracking and/or audio-video fencing.

### BACKGROUND

Audio-video capture systems have become increasingly sophisticated in recent years, particularly in collaborative video environments such as conference rooms, classrooms, and lecture halls. Applicant has identified a number of deficiencies of using systems to capture desirable audio and/or video content.

### BRIEF SUMMARY

Various embodiments of the present disclosure are directed to apparatuses, systems, methods, and computer readable media for providing a dynamic audio-video tracking and/or fencing for video environments. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example system configured to execute audio/video (AV) processing operations in accordance with one or more embodiments disclosed herein;

FIG. 2 illustrates an example AV processing apparatus configured in accordance with one or more embodiments disclosed herein;

FIG. 3 illustrates an example system associated with source tracking modeling in accordance with one or more embodiments disclosed herein;

FIG. 4 illustrates an example video environment in accordance with one or more embodiments disclosed herein;

FIG. 5 illustrates another example video environment in accordance with one or more embodiments disclosed herein;

FIG. 6 illustrates another example video environment in accordance with one or more embodiments disclosed herein;

FIG. 7 illustrates another example video environment in accordance with one or more embodiments disclosed herein;

FIG. 8 illustrates another example video environment in accordance with one or more embodiments disclosed herein;

FIG. 9 illustrates yet another example video environment in accordance with one or more embodiments disclosed herein; and

FIG. 10 illustrates an example method for providing dynamic audio-video tracking and/or fencing for video environments in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

An audio video (AV) conferencing system may include one or more video cameras to capture video data in a video environment. An AV conferencing system may also include a microphone array configured with beamforming functionality to focus audio capture on particular audio sources in the video environment. The captured audio and/or video data may be transmitted between devices in the video environment and/or another environment via a network. The processed audio and/or video data may also be transmitted to one or more output devices such as one or more display devices or one or more speakers. In certain scenarios, a video environment may be a conference room environment with one or more video cameras and/or one or more microphone arrays. For example, a traditional AV conferencing system may utilize multiple microphones and cameras to capture audio and video content from various content sources within a video environment. However, a traditional AV conferencing system is typically incapable of selectively capturing desired content while excluding undesirable content from specific areas or content sources of a video environment. For example, a microphone array may capture undesirable audio from one or more audio sources within the video environment, potentially disrupting an audio stream for the video environment. Additionally, a video capture may capture undesirable video from one or more areas within the video environment, potentially disrupting a video stream for the video environment. Moreover, a traditional AV conferencing system is typically incapable of dynamically adapting capture of video and/or audio content based on real-time activity within a video environment. As such, an intelligent and adaptive AV conferencing system for capturing audio and/or video content is desirable.

Various examples disclosed herein provide enhanced audio-visual content capture in collaborative environments. For instance, dynamic AV tracking and/or fencing for a video environment may be provided to enhance capture of audio content and/or video content associated with the video environment. In some examples, tracking of visual and audio sources may be improved based on combined audio and video cues associated with audio data, video data, and/or metadata. Data from one or more sensors in the video environment may also be utilized. In some examples, focused capture on specific regions of interest within the video environment may be provided by steering microphone beams, video cameras, and/or virtual cameras to enhance audio and video capture from objects, individuals, or sounds within the regions of interest while attenuating or excluding content from other areas of the video environment.

Additionally, fencing regions may be dynamically determined and/or adjusted based on detected events, objects, and/or activities associated with a video stream and/or an audio stream, thereby providing adaptive content capture capabilities for an AV system. As such, the quality and relevance of captured audio and/or visual content may be enhanced while mitigating undesired audio and video capture in various video environments. This further enables fine-tuned audio and/or video capture in real-time for consistent audio and video output for an AV system. The AV system may be an AV conferencing system or another type of AV system associated with AV capture, mixing, and/or production. Improved isolation between microphone lobes and audio output devices may also be provided. Additionally, improved localization and/or identity tracking for a source of interest in an audio environment may also be provided. This enables seamless and accurate capture of audio content and/or video content associated with a source of interest within a video environment, even as positions of the source of interest change within the video environment.

Accordingly, a comprehensive approach to enhancing audio-visual processing in video environments may be provided through dynamic tracking and fencing capabilities. By integrating audio and video data for source tracking, improved accuracy in locating and tracking sources of interest may also be provided. Additionally, the dynamic adjustment of regions of interest based on real-time activities may enable an AV system to adapt to changing conditions within a video environment, ensuring that the most pertinent content is captured and processed by the AV system. For example, in a conference room setting, the AV system may automatically shift focus to an active speaker or a newly introduced visual aid. Moreover, the ability to remove undesired audio and video sources outside a defined region of interest may further improve the quality and relevance of captured content. For example, a virtual boundary may be created within a video environment, allowing for selective capture that focuses on the most desirable content while excluding distractions or sensitive areas within the video environment. As such, the multi-modal approach that integrates audio and video data for informing tracking and/or fencing allows for more robust tracking and/or fencing, especially in challenging scenarios where audio or video alone might be insufficient.

### Example Audio/Video (AV) Processing Systems and Methods

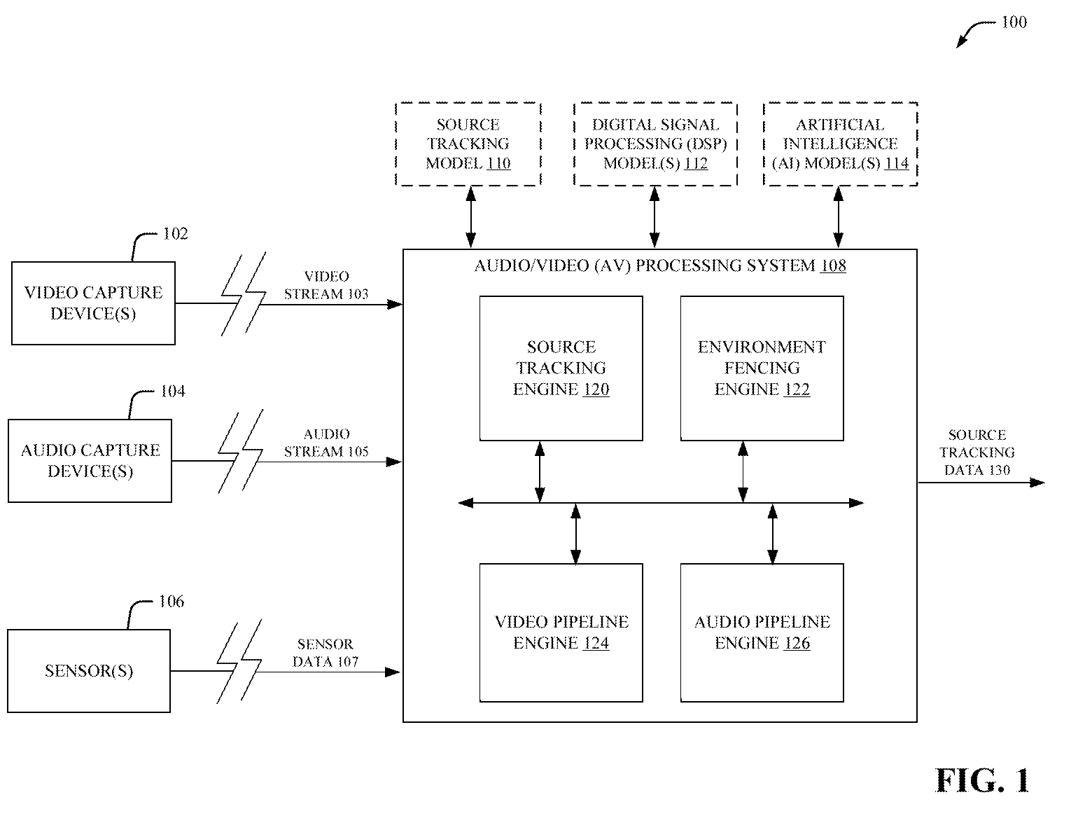

FIG. 1 illustrates a system 100 that is configured to provide dynamic audio-video tracking and/or fencing for a video environment, according to embodiments of the present disclosure. The system 100 may be, for example, a video environment system, a conferencing system (e.g., a conference audio system, a video conferencing system, an audio video (AV) conferencing system, a digital conference system, etc.), a lecture hall system, a classroom system, a live event system, a music venue system, a sporting event system, a house of worship system, an automobile advanced driver assistance system (ADAS), a digital media content workstation, a broadcasting system, an augmented reality system, a virtual reality system, a gaming system, an online gaming system, or another type of video system. Additionally, the system 100 may be implemented as a video processing apparatus and/or as software that is configured for execution on a network device, a video capture device, a smartphone, a laptop, a personal computer, a digital conference system, a wireless conference unit, a video workstation device, or another device. In some examples, the system 100 disclosed herein may be integrated into a virtual video processing system (e.g., video processing via virtual processors or virtual machines) with other audio and/or digital signal processing.

The system 100 may be utilized for various types of applications such as, but not limited to: source tracking including audio source tracking and/or video source tracking, individual framing for video conferencing or other AV systems, steering one or more beamformed lobes of a microphone array, providing source tracking information for artificial intelligence (AI) applications, source localization within a video environment for use with a microphone array, etc.

By providing dynamic audio-video tracking and/or fencing for a video environment, the system 100 may provide various improvements related to video processing such as, for example: enhanced accuracy for source tracking by integrating audio data and video data for source track modeling, improved content relevance by dynamically adjusting regions of interest based on real-time activities within a video environment, removal of undesired audio and/or undesirable video sources outside a defined region of interest, increased flexibility for content capture through user-defined or automatically generated virtual fencing; optimized resource utilization by allocating processing resources to regions of interest of a video environment, improved audio quality through adaptive microphone beam steering based on visual and/or audio cues, enhanced video framing and composition by leveraging audio source information, and/or one or more other technical improvements. The system 100 may also be adapted to produce improved audio signals and/or improved video signals with reduced noise, reduced reverberation, improved source separation, and/or a reduction in other undesirable audio artifacts.

Accordingly, the system 100 provides a comprehensive approach to enhancing audio-visual processing in video environments through dynamic tracking and fencing capabilities. By integrating audio and video data for source tracking, the system 100 may enable improved accuracy in locating and tracking sources of interest. This multi-modal approach allows for more robust tracking, especially in challenging scenarios where audio or video alone might be insufficient.

Additionally, the dynamic adjustment of regions of interest based on real-time activities may enable the system 100 to adapt to changing conditions within the video environment, ensuring that the most pertinent content is captured and processed. For example, in a conference room setting, the system 100 may automatically shift focus to an active speaker or a newly introduced visual aid. Moreover, the ability to remove undesired audio and video sources outside a defined region of interest may further improve the quality and relevance of captured content. For example, a virtual boundary may be created within a video environment, allowing for selective capture that focuses on the most desirable content while excluding distractions or sensitive areas within the video environment.

By utilizing user-defined or automatically generated virtual fencing, the system 100 may also provide increased flexibility in content capture. This allows for customization based on specific use cases or environments, enabling users to tailor the behavior of the system 100 to desired functionality. For instance, in a lecture hall, an instructor may define specific areas for student participation while excluding others.

The optimized resource utilization provided by the system 100 may be achieved by allocating processing resources to regions of interest, thereby enhancing overall efficiency. As such, computational power may be optimally focused for particular computing tasks, thereby reducing latency and improving real-time performance of the system 100.

Adaptive microphone beam steering based on visual and audio cues may also enable the system 100 to provide improved audio quality. By dynamically adjusting the focus of audio capture in response to both visual and audio information, the system 100 may provide clear audio even as speakers move or multiple speakers speak simultaneously.

In some examples, the system 100 may enhance video framing and composition by leveraging audio source information. For example, the system 100 may automatically adjust camera angles or zoom levels based on the location of an active speaker, ensuring optimal visual presentation for a video stream.

The system 100 may also provide improved audio and video signals with reduced noise, reduced reverberation, and/or improved source separation to address challenges in audio-visual capture within a video environment. These improvements may enable more intelligible audio output and/or more focused video output. The reduction of undesirable audio artifacts may further enhance the overall quality of the captured content, thereby configuring the content for various applications such as teleconferencing, lecture recording, or broadcast production.

In some examples, the system 100 may provide an improved source tracking model by combining raw detection data from both audio and video algorithms (e.g., digital signal processing (DSP) and/or AI). For example, by implementing a source tracking model that inputs both raw detection data from video AI (e.g., raw key points and bounding boxes from one or more video capture devices at a particular frame rate) and raw angle of arrival detections of audio from audio DSP to improve object location prediction (e.g., both raw data sources may be input together into a Kalman filter to output more accurate two-dimensional (2D) or three-dimensional (3D) location estimates. In another example, raw video frame data may be provided along with a raw digital audio signal to a source tracking model trained to predict locations directly from combined modality input.

As disclosed herein, a video environment may be an indoor environment, an outdoor environment, a room (e.g., a conference room or another room in an indoor environment), a lecture hall, a performance hall, an auditorium, a broadcasting environment, a sports stadium or arena, a virtual environment, or another type of audio environment. In various examples, the audio signal processing system 100 may be configured to optimize audio capture and/or audio source tracking associated with one or more beamforming lobes of a microphone array via digital signal processing. In some examples, the audio signal processing system 100 may be configured to optimize audio capture and/or audio source tracking associated with one or more beamforming lobes via machine learning and/or by utilizing one or more trained machine learning models.

The audio signal processing system 100 may also be employed for another type of audio processing application such as, but not limited to, active noise cancelation, adaptive noise cancelation, etc. In some examples, the system 100 may enable enhancement of generation video enabled products or other types of video content applications. In some examples, the system 100 may utilize source tracking to provide accurate and robust person tracking in real-time for use on embedded devices and/or other AV conferencing systems.

The dynamic audio-video tracking and/or fencing provided by the system 100 may be performed with improved processing speed and/or a reduced number of computing resources by improving the audio and video content relevance based on real-time activities associated with a video environment. Moreover, by utilizing video content processing based on source tracking modeling, the system 100 may minimize network latency and/or bandwidth utilization for transmitting video data. For example, by improving accuracy of source tracking modeling and/or environment fencing, the system 100 may reduce network bandwidth by transmitting modeling results along with filtered video data rather than mere transmittal of unprocessed video data. In some examples, the system 100 may improve efficiency and/or quality of video processing by a video capture device. For example, improved video output related to a source of interest in video content and/or in a FOV of a video capture device may be provided via the improved source tracking and/or environment fencing provided by the system 100.

The system 100 may also provide video streams for rendering via one or more display devices. In some examples, a display device may receive a video stream via a physical interface protocol such as a universal serial bus (USB) communication protocol or another type of communication protocol. In some examples, a display device may receive a video stream via a network communication protocol such as an Internet Protocol (IP), IP over Ethernet (IPoE), or other network communication protocol. In some examples, a display device may be a virtual camera or another type of virtual device.

The system 100 includes one or more video capture devices 102, one or more audio capture devices 104, and/or one or more sensors 106. The one or more video capture devices 102 may respectively be devices configured to capture video related to the one or more sound sources. The one or more video capture devices 102 may include one or more sensors configured for capturing video by converting light into one or more electrical signals. The video captured by the one or more video capture devices 102 may also be converted into a video stream 103. In an example, the one or more video capture devices 102 are one or more video cameras. The one or more video capture devices 102 may be configured to capture video related to one or more sources of interest within a video environment. In some examples, the one or more video capture devices 102 enable tracking of a source of interest in a video environment. The source of interest may be an audio source, a sound source, a speaker, a presenter, a participant, a visual object, or another type of source of interest within the video environment. For example, the source of interest may be located within the video environment and may be identified for tracking and/or capture by the AV processing system 108. The source of interest may be associated with both audio content and video content. Alternatively, the source of interest may be associated with only audio content or only video content.

The one or more audio capture devices 104 may respectively be devices configured to capture audio from one or more sound sources. The one or more audio capture devices 104 may include one or more sensors configured for capturing audio by converting sound into one or more electrical signals. The audio captured by the one or more audio capture devices 104 may also be converted into an audio stream 105. The audio stream 105 may be a digital audio data or, alternatively, analog audio data, related to the one or more electrical signals. In some examples, the audio stream 105 may include beamformed audio data. In some examples, the one or more audio capture devices 104 may be configured to capture audio from one or more sound sources in the video environment.

In an example, the one or more audio capture devices 104 are one or more microphone arrays. For instance, the one or more audio capture devices 104 may correspond to a microphone array, one or more microphones of a microphone array, one or more linear microphones of a microphone array, one or more ceiling microphone arrays, one or more table microphone arrays, or other types of microphone arrays. In some examples, the one or more audio capture devices 104 generate and/or utilize one or more beamformed lobes to enable capture of audio. In alternate examples, the one or more audio capture devices 104 are another type of capture device such as, but not limited to, one or more condenser microphones, one or more micro-electromechanical systems (MEMS) microphones, one or more dynamic microphones, one or more piezoelectric microphones, one or more virtual microphones, one or more network microphones, one or more ribbon microphones, and/or another type of microphone configured to capture audio.

The one or more sensors 106 may respectively be devices configured to capture environmental data associated with the video environment. The one or more audio capture devices 104 may include one or more transducers or other sensing elements configured for converting environmental information into one or more electrical signals. The environmental information captured by the one or more sensors 106 may also be converted into sensor data 107. The sensor data 107 may be a digital sensor data or, alternatively, analog sensor data, related to the one or more electrical signals. In some examples, the one or more sensors 106 includes one or more infrared capture devices, one or more acoustic sensor devices, one or more motion sensor devices, one or more proximity sensor devices, one or more depth sensor devices, one or more radar sensor devices, one or more Light Detection and Ranging (LiDAR) sensor devices, one or more millimeter wave sensor devices, one or more time-of-flight (ToF) sensor devices, and/or one or more other types of sensors. As such, the sensor data 107 may include motion sensor data, proximity sensor data, radar sensor data, LiDAR sensor data, millimeter sensor data, TOF sensor data, and/or other sensor data associated with the video environment.

The one or more video capture devices 102, the one or more audio capture devices 104, and/or the one or more sensors 106 may be positioned within the video environment or proximate to the video environment. In some examples, the one or more audio capture devices 104 may be associated with a coverage area of video environment. For example, the one or more audio capture devices 104 may be located within the coverage area or proximate to the coverage area to enable capture of at least a portion of the audio stream 105 via the coverage area. In some examples, the audio stream 105 includes audio captured from two or more coverage areas within an audio environment. For instance, the audio stream 105 may include mixed audio associated with two or more coverage areas. A coverage area may be an area within the video environment that is associated with one or more audio sources.

The system 100 also includes an AV processing system 108, a source tracking model 110, one or more DSP models 112, and/or one or more artificial intelligence (AI) models 114. The AV processing system 108 may process data associated with the one or more video capture devices 102, the one or more audio capture devices 104, the one or more sensors 106, the one or more DSP models 112, and/or the one or more AI models 114. For example, the AV processing system 108 may process audio data, video data, sensor data, and/or metadata associated with the one or more video capture devices 102, the one or more audio capture devices 104, the one or more sensors 106, the one or more DSP models 112, and/or the one or more AI models 114. As illustrated in FIG. 1, the AV processing system 108 includes a source tracking engine 120, environment fencing engine 122, a video pipeline engine 124, and/or an audio pipeline engine 126.

A DSP model of the one or more DSP models 112 may be computational model that utilizes one or more DSP techniques to process, analyze, and/or transform audio data, video data, and/or sensor data. The one or more DSP models 112 may be configured to generate audio modeling data and/or video modeling data for input to the source tracking model 110. The one or more DSP models 112 may process the audio stream 105 from the one or more audio capture devices 104 to generate audio data 324 and/or metadata 326. The one or more DSP models 112 may also process the video stream 103 from the one or more video capture devices 102 to generate video data and/or metadata. The one or more DSP models 112 may utilize techniques such as beamforming, direction of arrival estimation, time difference of arrival estimation, spectral analysis, frequency domain transformations, Kalman filtering, optical flow analysis, edge detection, motion estimation, and/or other digital signal processing techniques. The one or more DSP models 112 may also provide audio data, the video data, and/or the metadata to the AV processing system 108 to enable the source tracking engine 120 to generate source tracking data 130.

An AI model of the one or more AI models 114 may be a computational model that utilizes one or more machine learning techniques to process, analyze, and/or interpret audio data, video data, and/or sensor data. The one or more AI models 114 may be configured to generate audio modeling data and/or video modeling data for input to the source tracking model 110. The one or more AI models 114 may process the audio stream 105 from the one or more audio capture devices 104 to generate audio data and/or metadata. The one or more AI models 114 may also process the video stream 103 from the one or more video capture devices 102 to generate video data and/or the metadata. The one or more AI models 114 may include a neural network model, a deep learning model, a convolutional neural network model, a recurrent neural network model, a transformer model, and/or another type of machine learning model. Additionally, the one or more AI models 114 may be configured to perform object recognition, facial detection and recognition, activity classification, depth estimation, speaker identification, speech recognition, audio event detection, and/or one or more types of AI-based analysis. The one or more AI models 114 may provide audio data, video data, and/or metadata to the AV processing system 108 to enable the source tracking engine 120 to generate the source tracking data 130.

The AV processing system 108 may utilize the source tracking engine 120 to enable source tracking functionality for one or more sources of interest in the video environment. The source tracking engine 120 may receive audio data associated with the audio stream 105, the one or more DSP models 112, and/or the one or more AI models 114. For example, the audio data may be raw audio data associated with the audio stream 105, audio modeling data provided by the one or more DSP models 112, and/or audio modeling data provided by the one or more AI models 114. Additionally, the source tracking engine 120 may receive video data associated with the video stream 103, the one or more DSP models 112, and/or the one or more AI models 114. For example, the video data may be raw video data associated with the audio stream 105, video modeling data provided by the one or more DSP models 112, and/or video modeling data provided by the one or more AI models 114.

The raw audio data may refer to audio data that has not been processed by the one or more DSP models 112 or the one or more AI models 114. Raw audio data may include unprocessed audio samples captured by the one or more audio capture devices 104 and provided via the audio stream 105. For example, raw audio data may include a series of amplitude values sampled at defined intervals such as 16-bit samples captured at 44,100 times per second or another sampling rate. Raw audio data may also include minimally processed audio data that has undergone basic signal conditioning such as analog-to-digital conversion, gain adjustment, and/or filtering but has not been subjected to higher-level processing such as beamforming, source separation, speech recognition, or audio event detection.

The raw video data may refer to video data that has not been processed by the one or more DSP models 112 or the one or more AI models 114. Raw video data may include unprocessed video frames captured by the one or more video capture devices 102 and provided via the video stream 103. For example, raw video data may include a sequence of digital video frames respectively including pixel values that encode color information and/or brightness information. Raw video data may also include minimally processed video data that has undergone basic signal conditioning such as analog-to-digital conversion, color space conversion, and/or compression but has not been subjected to higher-level processing such as object detection, facial recognition, motion estimation, or activity classification.

In some examples, the source tracking engine 120 may determine a region of interest associated with the video environment. In some examples, the source tracking engine 120 may input the audio data and the video data to the source tracking model 110 to generate the source tracking data 130 for a source of interest within the region of interest. The region of interest may be a defined area within a video environment where audio capture and/or video capture is enabled or prioritized. The region of interest may be defined by a boundary, a set of coordinates, a geometric shape, and/or another spatial representation. The region of interest may also be determined based on user input, automatic detection of sources of interest, predefined configurations, and/or real-time analysis of audio and video content within the video environment. By integrating both audio data and video data into a source tracking modeling process, the source tracking engine 120 may provide improved accuracy in identifying and tracking the source of interest within the video environment.

The source tracking data 130 may be output data generated by the source tracking model 110. Additionally, the source tracking data 130 may comprise tracking information for one or more sources of interest within the video environment. The source tracking data 130 may be generated based on processing of audio data associated with the audio stream 105, video data associated with the video stream 103, and/or the sensor data 107 from the one or more sensors 106. For instance, the source tracking data 130 may comprise one or more: position estimates, velocity estimates, trajectory information, identity information, confidence scores, and/or other tracking information for sources of interest. The source tracking data 130 may also be output by the source tracking engine 120 to one or more output devices, the video pipeline engine 124, the audio pipeline engine 126, and/or one or more other components of an AV processing system 108 to enable downstream processing based on the source tracking data 130.

In some examples, the source tracking engine 120 may utilize information from both audio data and video data to improve the source tracking functionality for one or more sources of interest in the video environment. For instance, the source tracking engine 120 may combine raw detection coordinates from an audio detector and a video detector to improve the source tracking functionality for one or more sources of interest in the video environment. The raw detection coordinates may be formatted in a 3D representation, in real-time, and/or over a particular time window associated with the video stream 103 and/or the audio stream 105. In some examples, estimated coordinate values of the source tracking data 130 may be based on contributions from both audio data and video data.

The source tracking model 110 may be a computational model configured to process audio data, video data, and/or sensor data to generate tracking information for one or more sources of interest within a video environment. The source tracking model 110 may be implemented as an AI model (e.g., a machine learning model), a DSP model, a hybrid model combining AI and DSP techniques, and/or another type of computational model. The source tracking model 110 may receive input data from a single modality or multiple modalities. Additionally, the source tracking model 110 may output the source tracking data 130. The source tracking data 130 may comprise one or more position estimates, velocity estimates, identity information, and/or other tracking information for a source of interest.

The source tracking engine 120 may also apply weighting or prioritization between the audio data and video data to optimize the source tracking data 130. In some examples, the source tracking model 110 may utilize weighting or prioritization between the audio data and video data to generate the source tracking data 130. The weighting or prioritization may be dynamically determined by the source tracking engine 120 based on real-time processing characteristics of the AV processing system 108, a particular configuration of the one or more video capture devices 102 and/or the one or more audio capture devices 104 (e.g., the combination, quantity, or arrangement of audio and video capture devices within a video environment), and/or characteristics of the video environment (e.g., room geometry, room acoustics, or other environmental factors associated with the video environment).

The source tracking model 110 may also utilize features derived from video cameras and microphones through a motion model (e.g., a Kalman filter). Parameters which derive the features from audio and video and/or matrices which parametrize the motion model may be optimized to minimize a loss function that measures error between estimated and actual 3D locations of a source of interest. As such, by integrating both audio data and video data into a source tracking modeling process with optimized weighting, the source tracking engine 120 may provide improved accuracy for identifying and/or tracking a source of interest within the video environment.

The source tracking model 110 may also utilize features associated with known or estimated positions of devices within the video environment. The devices may include one or more: sensors, microphones, and/or cameras. For example, the features may include object coordinate estimates associated with estimated or know geometric placement and/or orientation of the devices within the video environment. In some examples, photogrammetry may be utilized to estimate geometric placement and/or orientation of the devices if not known (e.g., if a sensor such as a microphone includes a camera). Further, triangulation, trilateration, multilateration, and/or another position estimation technique may be utilized to estimate additional coordinates from known or estimated positions of devices.

In some examples, the source tracking engine 120 may select either audio data or video data for utilization by the source tracking model 110 based on a determination that conflicting information exists between the audio data and video data. The source tracking engine 120 may utilize one or more AI techniques and/or one or more DSP techniques to identify discrepancies in audio data and video data. In an example where audio is detected in a region of the video environment where no visual objects of interest are present, or conversely where visual objects are identified in areas with no corresponding audio, the source tracking model 110 may adaptively utilize single modality tracking such that either audio data or video data is provided as input to the source tracking model 110. Accordingly, accurate source tracking functionality of the source tracking model 110 may maintained even when one modality provides limited or conflicting information.

The source tracking engine 120 may also utilize at least a portion of the sensor data 107 to determine a false positive associated with source tracking data 130. The source tracking model 110 may implement one or more AI techniques and/or one or more DSP techniques to process and reconcile discrepancies in the multimodal data. For instance, the source tracking engine 120 may utilize at least a portion of the sensor data 107 to cross-validate and/or confirm a location of a source of interest within the video environment. In some examples, the source tracking engine 120 may simultaneously analyze the video stream 103 and the audio stream 105 to enable cross-referencing of data between modalities. For instance, an audio source may be utilized to determine sound direction while a video source may be utilized to determine whether a source of interest is within or outside an area of interest based on the audio-derived positioning information. Additionally, the area of interest information associated with the source of interest may be further utilized to determine whether or not to utilize related audio data via the source tracking model 110.

In some examples, the source tracking engine 120 may correlate newly detected source tracking data 130 with previously determined source tracking data. For instance, the source tracking engine 120 may utilize a cost function to quantify a difference between newly detected source tracking data 130 and previously determined source tracking data. In response to a determination that a difference between newly detected source tracking data 130 and previously determined source tracking data is equal to or greater than a predefined threshold, the source tracking engine 120 may be configured to reject and/or withhold output of the newly detected source tracking data 130 to maintain integrity and/or accuracy of the source tracking data 130.

The source tracking model 110 may implement one or more AI techniques and/or one or more DSP techniques. For example, the source tracking model 110 may be configured as an AI source tracking model. In some examples, the source tracking model 110 may be a neural network model, a deep learning model, a convolutional neural network model, and/or another type of machine learning model. In some examples, the source tracking model 110 may utilize or more AI techniques to process data from both audio and video streams simultaneously, allowing for more nuanced and adaptive tracking of sources of interest within the video environment. A neural network model may learn intricate patterns and relationships in the input data, enabling the neural network model to identify and track sources within the video environment. A deep learning model may include multiple layers of processing and/or may extract hierarchical features from raw audio and/or video data to improve accuracy and robustness of source tracking.

A convolutional neural network may be utilized to analyze video streams and/or time-frequency representations of audio signals. In some examples, the source tracking model 110 may be configured as a DSP source tracking model. For instance, the source tracking model 110 may utilize beamforming for audio localization, Kalman filtering for trajectory estimation, optical flow analysis for visual tracking, and/or one or more other types of DSP techniques to track a source of interest in the video environment. In some examples, the source tracking model 110 may be configured as a hybrid AI and DSP source tracking model.

The source tracking model 110 may utilize one or more source tracking techniques to track one or more sources of interest within the video environment. For instance, the source tracking model 110 may utilize a Kalman filter to estimate a state of a source of interest based on noisy observations from the video stream 103 and/or the audio stream 105. The Kalman filter may maintain a state vector representing a position and/or a velocity of the source of interest. Additionally, the Kalman filter may iteratively perform a prediction step and an update step. During the prediction step, the Kalman filter may propagate the state vector forward in time based on a motion model. During the update step, the Kalman filter may incorporate new observations to refine the state estimate. The Kalman filter may also maintain a covariance data structure such as a covariance data matrix representing uncertainty in the state estimate, which may be utilized to weight the relative contributions of the prediction and the observation.

In some examples, the source tracking model 110 may perform optical flow analysis to estimate motion of sources of interest between consecutive video frames. Optical flow may represent a pattern of apparent motion of objects, surfaces, and/or edges in a visual scene caused by relative motion between the video capture device 102 and the scene. The source tracking model 110 may compute dense optical flow that estimates motion for each pixel in a video frame, or sparse optical flow that estimates motion for a subset of feature points.

The source tracking model 110 may utilize one or more optical flow techniques such as a Lucas-Kanade optical flow that estimates motion for a set of feature points based on a particular flow within a local neighborhood and/or brightness constraints, a Horn-Schunck optical flow that computes optical flow by minimizing a global energy function that combines a brightness constraint with a smoothness constraint, a Farneback optical flow that estimates dense optical flow by approximating the neighborhood of each pixel using polynomial expansion and computing displacement fields based on polynomial coefficient changes between frames, a deep learning-based optical flow that utilizes a neural network trained on a datasets to predict optical flow fields directly from pairs of input frames, and/or another type of optical flow technique to compute the optical flow field.

Beamforming for audio localization may involve combining signals from multiple microphones of a microphone array to enhance signals arriving from a particular direction while attenuating signals from other directions. For instance, the source tracking model 110 may utilize delay-and-sum beamforming that applies time delays to align signals from a target direction before summing. The source tracking model 110 may also utilize minimum variance distortionless response (MVDR) beamforming that minimizes output power while maintaining unity gain in the target direction. The source tracking model 110 may also utilize generalized cross-correlation with phase transform (GCC-PHAT) to estimate time differences of arrival between microphone pairs, which may then be utilized to triangulate the position of an audio source.

In some examples, the source tracking model 110 may utilize a recurrent neural network (RNN) or a long short-term memory (LSTM) network to learn temporal patterns in the motion of sources of interest. The RNN or LSTM may receive a sequence of observations as input and may output predicted positions or velocities for the sources of interest. The RNN or LSTM may learn to model particular motion patterns and the source tracking model 110 may utilize a transformer architecture with attention mechanisms to model long-range temporal dependencies in the tracking data.

The source tracking model 110 may also utilize a graph neural network (GNN) to model interactions between multiple sources of interest. The GNN may represent the sources of interest as nodes in a graph and may model pairwise interactions as edges. The GNN may propagate information between nodes to capture how the motion of one source of interest may influence the motion of another source of interest.

To provide source tracking for one or more sources of interest in the video environment, the source tracking model 110 may utilize one or more 3D ray-based techniques. For instance, the source tracking model 110 may generate 3D rays from multiple sources such as the one or more video capture devices 102, the one or more audio capture devices 104, and/or the one or more sensors 106. A 3D ray may represent a directional vector originating from a capture device and extending into the video environment toward a detected source of interest. In some examples, the source tracking model 110 may generate a first set of 3D rays based on video data associated with the video stream 103 and a second set of 3D rays based on audio data associated with the audio stream 105. The source tracking model 110 may additionally generate a third set of 3D rays based on sensor data 107 from the one or more sensors 106.

The source tracking model 110 may also determine geometric primitives based on the 3D rays. The geometric primitives may comprise points, lines, planes, and/or other geometric representations derived from the 3D rays. For instance, the source tracking model 110 may determine an intersection point where two or more 3D rays converge, thereby indicating a probable location of a source of interest in 3D space. The geometric primitives may include line segments representing portions of 3D rays, planes representing surfaces within the video environment, and/or bounding volumes representing spatial regions associated with sources of interest. The source tracking model 110 may utilize the geometric primitives to construct a spatial representation of the video environment and/or the sources of interest within the video environment.

The source tracking model 110 may determine rays and points to enabling sensing in 3D space based on the geometric primitives. For instance, the source tracking model 110 may identify candidate 3D locations by analyzing intersections and near-intersections of rays from different capture devices. In some examples, the source tracking model 110 may utilize geometric features to constrain the search space for matching rays across multiple video capture devices 102. The source tracking model 110 may also utilize triangulation techniques to determine 3D coordinates of a source of interest based on corresponding rays from two or more capture devices.

The source tracking model 110 may perform ray matching for cost analysis to associate rays from different capture devices with the same source of interest. The ray matching may involve computing a cost function that quantifies a similarity or distance between rays. For instance, the cost function may measure a perpendicular distance between rays, an angular difference between ray directions, and/or a temporal correlation between detection events associated with the rays. In some examples, the source tracking model 110 may utilize a cost matrix to represent pairwise costs between rays from different capture devices.

The source tracking model 110 may also perform matching operations involving points in addition to rays. For instance, the source tracking model 110 may perform ray-to-point matching, point-to-point matching, and/or combinations of ray-to-ray, ray-to-point, and point-to-point matching depending on the available depth information for respective detections. A point may represent a 3D location of a source of interest where depth information is known or inferred. In contrast, a ray may represent a directional vector where depth information is unavailable.

Depth information may be obtained from various sources to enable point-based matching. For instance, depth information may be directly available from the sensor data 107 associated with the one or more sensors 106 such as a LiDAR sensor, a ToF sensor, a depth sensor, and/or a stereo camera system. Depth information may also be inferred using heuristics or assumptions such as assuming a known object size and utilizing focal length and lens distortion parameters of a detecting camera to estimate distance. Additionally, depth information may be produced by a depth estimation model such as a neural network (e.g., the one or more AI models 114) trained to predict depth from monocular images. Depth information may also be computed from triangulation based on a previous association of rays, where a point for a previous timestep is derived from the intersection of rays from multiple sensors.

The source tracking model 110 may utilize one or more graph optimization techniques where detections from different sensors are represented as nodes and potential associations are represented as edges. The cost associated with each edge may be computed based on the type of geometric information available for the corresponding detections. For instance, a ray-to-ray cost may be computed based on a perpendicular distance between rays or an angular difference between ray directions. A ray-to-point cost may be computed based on a distance from the point to the ray. A point-to-point cost may be computed based on a Euclidean distance between the points. The computed costs may be utilized as weights in a cost matrix or as edge weights in a graph representation.

The source tracking model 110 may also utilize mixed-integer linear programming (MILP) modeling to perform the matching operations. The MILP may include binary decision variables representing candidate associations between rays or points from different sensors. The MILP modeling may also include linear constraints encoding feasibility of the assignment and a linear objective function encoding the association cost. The objective function may minimize a total cost computed from the ray-to-ray, ray-to-point, and/or point-to-point costs for the selected associations.

The linear constraints of the MILP modeling may include a uniqueness constraint and/or a transitivity constraint. The uniqueness constraint may enforce that a given detection from a first sensor is associated with at most one detection from each other sensor. The transitivity constraint may enforce that, if a first detection from a first sensor is associated with a detection from a second sensor, and that detection from the second sensor is associated with a detection from a third sensor, then the detection from the first sensor is also associated with the detection from the third sensor. The transitivity constraint may therefore provide consistent association of detections across three or more sensors.

The source tracking model 110 may also avoid matching detections originating from the same sensor with each other by not generating a decision variable for such associations. For instance, no edge may be generated in the graph between nodes representing detections from the same sensor. This approach may be utilized when a sensor and the models extracting data from the sensor are expected to produce exactly one detection per object.

The MILP modeling may enable the source tracking model 110 to improve assignment across sensors and time at each step. The MILP modeling may also be tractable by reducing the input size through thresholding, gating, and/or constraints. For example, if a particular MILP workflow cannot produce a desirable solution within a particular time limit, the source tracking model 110 may utilize a previous solution from the MILP workflow or a previous MILP workflow.

The source tracking model 110 may also apply one or more assignment optimization techniques to minimize a total cost and determine an assignment of rays to sources of interest. For example, an assignment optimization technique may comprise a Hungarian optimization technique that iteratively reduces the cost matrix to identify a desirable one-to-one matching between rays and sources of interest, a greedy matching technique that sequentially assigns each ray to a lowest-cost source of interest while respecting assignment constraints, an auction technique that iteratively adjusts assignments until an equilibrium is reached where each ray is assigned to a source of interest that maximizes a particular goal, and/or another type of assignment optimization technique.

In examples where the system 100 includes multiple video capture devices 102, the source tracking model 110 may utilize one or more multi-camera 3D ray techniques to enable source tracking for one or more sources of interest. For instance, the source tracking model 110 may generate a respective 3D ray from each video capture device 102 based on a detected feature point, bounding box centroid, or other visual detection associated with a source of interest. Each 3D ray may originate from a known or estimated position of the respective video capture device 102 and extend through the detected pixel location into the video environment. The source tracking model 110 may utilize intrinsic camera parameters such as focal length, principal point, and/or lens distortion coefficients to transform pixel coordinates into normalized camera coordinates. The source tracking model 110 may further utilize extrinsic camera parameters such as rotation and translation relative to a world coordinate system to express each 3D ray in a common reference frame.

The source tracking model 110 may determine geometric primitives for multi-camera configurations based on the 3D rays generated from the multiple video capture devices 102. For instance, the source tracking model 110 may compute lines that represent the projection of a 3D ray from a first video capture device onto the image plane of a second video capture device. The source tracking model 110 may utilize a data matrix to relate corresponding points between pairs of video capture devices 102. The geometric primitives may also include data representing the projection of one camera center onto the image plane of another camera, planes defined by a 3D point and the camera centers of two video capture devices, and/or rectified image pairs where lines are aligned horizontally to enable correspondence search.

The source tracking model 110 may perform multi-camera ray matching to associate detections from different video capture devices 102 with the same source of interest. In some examples, the ray matching may involve computing a reprojection error that measures a distance between a projected 3D point and a detected feature point in each camera view. For instance, given a candidate 3D location, the source tracking model 110 may project the candidate location onto each camera image plane and compute a sum of squared distances to the respective detected feature points. The source tracking model 110 may also minimize the reprojection error to refine the estimated 3D location of the source of interest.

The source tracking model 110 may also utilize appearance-based matching to improve multi-camera ray association. For instance, the source tracking model 110 may extract visual descriptors such as color histograms, texture features, and/or deep learning embeddings from image portions surrounding detected feature points in each camera view. The source tracking model 110 may also compute a similarity score between descriptors from different cameras and utilize the similarity score in combination with geometric constraints to determine correspondence between detections. The appearance-based matching may be particularly useful when multiple sources of interest are present in the video environment.

The source tracking model 110 may generate one or more embeddings from video data and/or audio data to enable identification and tracking of sources of interest within the video environment. An embedding may be a latent representation of a source of interest that encodes distinguishing characteristics into a fixed-dimensional vector. The embedding may also capture semantic information regarding the source of interest in a compact numerical form that facilitates comparison and matching operations.

In some examples, the source tracking model 110 may generate feature embeddings from video data associated with the video stream 103. A feature embedding may encode visual characteristics of a source of interest such as shape, texture, color distribution, and/or spatial structure. The source tracking model 110 may utilize a convolutional neural network to extract hierarchical visual features from image regions containing a source of interest. The convolutional neural network may process an image region through multiple convolutional layers, pooling layers, and/or fully connected layers to produce a feature embedding vector. The feature embedding vector may have a dimensionality ranging from tens to thousands of elements depending on the complexity of the visual representation.

In some examples, the source tracking model 110 may generate appearance embeddings to encode the visual appearance of a source of interest for re-identification purposes. An appearance embedding may capture distinctive visual attributes that enable recognition of the same source of interest across different video frames, camera views, and/or lighting conditions. The source tracking model 110 may utilize a neural network trained with a contrastive loss function, a triplet loss function, and/or another metric learning objective to generate appearance embeddings. The metric learning objective may enable the neural network to produce similar embeddings for images of the same source of interest and dissimilar embeddings for images of different sources of interest.

The source tracking model 110 may also generate audio embeddings from audio data associated with the audio stream 105. An audio embedding may encode acoustic characteristics of a source of interest such as voice timbre, pitch patterns, speaking style, and/or spectral features. The source tracking model 110 may utilize a neural network that processes audio spectrograms, mel-frequency cepstral coefficients (MFCCs), and/or raw audio waveforms to produce an audio embedding vector. The audio embedding may enable speaker identification and/or speaker verification for sources of interest in the video environment.

In some examples, the source tracking model 110 may generate multi-modal embeddings that combine information from both video data and audio data. A multi-modal embedding may encode both visual and acoustic characteristics of a source of interest into a unified representation. The source tracking model 110 may generate the multi-modal embedding by concatenating separate video and audio embeddings, by utilizing a fusion network that learns to combine modality-specific features, and/or by utilizing a joint embedding space where video and audio representations are aligned. The multi-modal embedding may provide improved robustness for tracking and identification when one modality is degraded or unavailable.

The source tracking model 110 may utilize the embeddings to perform similarity matching between sources of interest. For instance, the source tracking model 110 may compute a distance metric such as Euclidean distance, cosine similarity, and/or another type of distance between embedding vectors to quantify similarity between sources of interest. The source tracking model 110 may utilize the similarity scores to associate detections across video frames, to re-identify sources of interest that temporarily leave and re-enter the region of interest, and/or to maintain consistent identity assignments for sources of interest over time.

The source tracking model 110 may also utilize an embedding database that stores embeddings for known sources of interest in the video environment. The embedding database may enable the source tracking model 110 to recognize previously observed sources of interest and to distinguish between different individuals or objects. The source tracking model 110 may update the embedding database over time by adding new embeddings for newly detected sources of interest and/or by refining existing embeddings based on additional observations. The source tracking model 110 may also utilize the embedding database to support enrollment of specific sources of interest for priority tracking within the video environment.

In some examples, the source tracking model 110 may utilize temporal consistency constraints to improve multi-camera ray matching over time. For instance, the source tracking model 110 may maintain a track history for each source of interest that includes previous 3D locations and associated camera detections. The source tracking model 110 may utilize the track history to predict expected detection locations in each camera view and constrain the ray matching search space based on the predictions.

In some examples, the source tracking model 110 may utilize a multi-view stereo technique to estimate dense 3D geometry of the video environment from the multiple video capture devices 102. The multi-view stereo technique may generate a depth map for each camera view by matching pixels across multiple views based on photometric consistency. The source tracking model 110 may utilize the dense 3D geometry to improve source tracking by providing contextual information regarding surfaces and/or objects in the video environment. The dense 3D geometry may also enable occlusion reasoning where the source tracking model 110 determines whether a source of interest is visible or occluded from each camera viewpoint.

Multi-sensor tracking may involve assignment of observations to tracked sources of interest. To enable real-time source tracking, the source tracking model 110 may utilize one or more techniques to reduce computational complexity and enable traceable multi-sensor tracking. In some examples, the source tracking model 110 may utilize a gating technique to reduce the number of candidate associations considered during ray matching. Gating may involve defining a validation region around each predicted source location and excluding observations that fall outside the validation region from consideration. The validation region may be defined based on a statistical threshold such as a threshold applied to a distance between a predicted location and an observation.

The source tracking model 110 may also utilize a temporal sliding window and/or a hierarchical decomposition technique to partition the multi-sensor tracking problem into smaller computational tasks. For instance, the source tracking model 110 may first cluster observations based on spatial proximity and then solve separate assignment problems for each cluster. The source tracking model 110 may also utilize a coarse-to-fine approach where an initial coarse solution is refined through successive iterations.

The source tracking model 110 may utilize parallel processing to accelerate computation of multi-sensor tracking solutions. For instance, the source tracking model 110 may distribute computation of cost matrix entries across multiple processing cores or utilize a graphics processing unit (GPU) to parallelize matrix operations. The source tracking model 110 may also utilize distributed computing techniques to partition the tracking problem across multiple computing nodes. Parallel processing may enable the source tracking model 110 to solve larger tracking problems within real-time constraints.

In some examples, the source tracking model 110 may utilize one or more sensor fusion techniques to combine data from the one or more video capture devices 102, the one or more audio capture devices 104, and/or the one or more sensors 106. The sensor fusion may be performed at particular stage of a processing pipeline such as at an early fusion stage performed prior to feature extraction, at a mid-level fusion stage performed prior to a final prediction stage, or at a late fusion stage that combines independent predictions from respective sensors.

The source tracking model 110 may utilize early sensor fusion where raw data from multiple sensors is combined prior to feature extraction. For instance, raw video frames from the video stream 103, raw audio samples from the audio stream 105, and/or raw sensor readings from the sensor data 107 may be concatenated or otherwise combined into a unified input representation. The unified input representation may then be processed by a neural network or other model to extract features and generate source tracking predictions. Early sensor fusion may enable the source tracking model 110 to learn cross-modal correlations directly from raw data.

The source tracking model 110 may utilize mid-level sensor fusion where features extracted from individual sensors are combined prior to a final prediction stage. For instance, the source tracking model 110 may extract visual features from the video stream 103 using a convolutional neural network, extract audio features from the audio stream 105 using a spectrogram-based model, and/or extract spatial features from the sensor data 107 using a point cloud processing model. The extracted features may then be concatenated, weighted, and/or otherwise combined into a fused feature representation. The fused feature representation may be provided to a subsequent processing stage to generate source tracking predictions. Mid-level sensor fusion may enable the source tracking model 110 to leverage modality-specific feature extractors while still capturing cross-modal relationships.

The source tracking model 110 may utilize late sensor fusion where independent predictions from individual sensors are combined to generate a final source tracking prediction. For instance, the source tracking model 110 may generate a first location estimate based on video data, a second location estimate based on audio data, and/or a third location estimate based on sensor data. The individual location estimates may then be combined using a weighted average, a voting scheme, a Kalman filter, and/or another fusion technique to generate a final location estimate for a source of interest. Late sensor fusion may enable the source tracking model 110 to maintain modularity and robustness, as individual sensor predictions may be independently validated and weighted based on confidence scores.

The source tracking model 110 may also dynamically select between early fusion, mid-level fusion, and late fusion based on real-time characteristics of the video environment, availability of sensor data, and/or processing constraints. For instance, the source tracking model 110 may utilize early fusion when raw data from two or more sensors is available and computational resources are sufficient, mid-level fusion when modality-specific preprocessing is beneficial, and/or late fusion when sensor reliability varies or when independent validation of sensor predictions is desirable.

In some examples, the source tracking model 110 may be a hybrid AI and DSP source tracking model. This hybrid approach may combine functionality of AI techniques and DSP techniques to enhance the accuracy and robustness of source tracking within the video environment. For instance, the source tracking model 110 may utilize a neural network with learned parameters in conjunction with DSP elements to process and analyze input data. The source tracking model 110 may also utilize a multi-stage processing pipeline. For example, audio data may be initially processed using one or more DSP techniques to generate a spectrogram representation. The spectrogram representation may then be provided as input to a neural network model to provide a source tracking prediction. In some examples, a neural network model may be utilized to predict information that is subsequently utilized by one or more DSP techniques to provide source tracking information.

The source tracking engine 120 may also determine the region of interest based on user input provided via a user interface of a user device. For example, a user may interact with a user interface to draw a boundary around a specific area of a room such as a podium or presentation area. In another example, a user may utilize a user interface to select predefined zones within the video environment such as a conference table or whiteboard area. The user interface may be a touchscreen display interface. In some examples, the user interface may provide a map view of the video environment to enable a user to select the region of interest from a plurality of regions of interest on the map view. The user interface may also present a live video feed for the video environment where a user may designate tracking zones for the video environment in real-time.

In some examples, the source tracking engine 120 may determine the region of interest based on user input provided via an application programming interface (API). The API may enable a programmatic definition and/or manipulation for the region of interest. The API may further enable integration with one or more external systems and/or applications with respect to the AV processing system 108. For instance, a room scheduling system may utilize the API to automatically set regions of interest based on a type of meeting or event scheduled at the video environment. In some examples, the AV processing system 108 may communicate with an external system and/or application via the API to define regions of interest that align with real-time actions in the video environment.

The source tracking engine 120 may also determine the region of interest based on independent analysis with respect to the video stream 103 and the audio stream 105. For example, the source tracking engine 120 may determine location information for a source of interest based on audio data associated with the audio stream 105. The location information may include a direction of arrival estimate for the source of interest, a position estimate for the source of interest, and/or other location information associated with the source of interest. The source tracking engine 120 may also determine facial recognition information for the source of interest based on video data associated with the video stream 103. The facial recognition information may include an identifier, a facial identifier, and/or other information to identify the source of interest. Additionally, the source tracking engine 120 may determine the region of interest based at least in part on the location information and the facial recognition information. As such, the source tracking engine 120 may combine information associated with the video stream 103 and the audio stream 105 to determine the region of interest based on real-time configuration of the video environment.

In some examples, the source tracking engine 120 may independently analyze both the video stream 103 and the audio stream 105. This multi-modal analysis may enable a more robust and accurate identification of the region of interest, particularly in dynamic environments where audio and visual cues may provide complementary information. In some examples, the source tracking engine 120 may process audio data from the audio stream 105 to determine location information related to the source of interest. The source tracking engine 120 may also determine the location information using one or more signal processing techniques such as beamforming, a time difference of arrival (TDOA) estimation, a direction of arrival estimation, acoustic source localization, or one or more other types of location estimation techniques. In some examples, a direction of arrival estimate may indicate an angle from which sound is coming and/or a position estimate associated with a 3D location of an audio source within the video environment. Additional location information may include confidence scores for the estimates, frequency characteristics of the source, or temporal consistency of the location over multiple audio frames.

The source tracking engine 120 may also analyze video data from the video stream 103 to perform facial recognition on the source of interest. In some examples, the facial recognition information may provide an identifier that may be utilized to track a source of interest across multiple video frames. Further, the facial identifier includes a feature vector that describes unique characteristics of a face or other physical quality of the source of interest.

In some examples, the source tracking engine 120 may enable adaptive and context-aware tracking of a source of interest in the video environment. For instance, if an audio localization estimation determines that a source of interest is located behind an obstacle, but facial recognition identifies a face of a known source of interest in a different location, the source tracking engine 120 may intelligently resolve this conflict to focus on the correct source of interest. As such, the source tracking engine 120 may utilize real-time configuration capability to enable the AV processing system 108 to adapt to real-time changes in the video environment, such as speakers moving around the video environment. Additionally, the source tracking engine 120 may be configured to utilize both audio and video information allows to provide seamless tracking even when one modality is temporarily unavailable or unreliable. Accordingly, a robust and flexible system for determining regions of interest may be provided.

In some examples, the source tracking engine 120 may utilize one or more language models to enable determining content of interest within the video environment. A language model may process textual representations derived from the audio stream 105 and/or the video stream 103 to identify semantically relevant content. For instance, the source tracking engine 120 may utilize a speech recognition model to transcribe audio from the audio stream 105 into text. Additionally, the source tracking engine 120 may provide the transcribed text to a language model for semantic analysis.

The language model may analyze the transcribed text to identify topics, keywords, entities, and/or concepts that indicate content of interest within the video environment. For instance, the language model may identify when a speaker mentions a particular product name, project identifier, action item, or other semantically significant term. The source tracking engine 120 may utilize the identified topics, keywords, entities, and/or concepts to prioritize tracking of the associated source of interest. For example, when a speaker begins discussing a high-priority topic, the source tracking engine 120 may increase a tracking priority for that speaker and/or adjust the region of interest to focus on the speaker.

The source tracking engine 120 may also determine the region of interest based on a keyword identified in the audio stream 105. For instance, the source tracking engine 120 may utilize a speech recognition model to process the audio stream 105 and identify one or more keywords within the transcribed audio. The keywords may include predefined terms, phrases, names, or other identifiers that indicate content of interest within the video environment. In response to identification of a keyword, the source tracking engine 120 may determine or adjust the region of interest to encompass a location associated with the source of interest that produced the keyword. For example, if a keyword such as a project name, a product identifier, or a speaker name is detected in the audio stream 105, the source tracking engine 120 may determine the region of interest to focus on the speaker who uttered the keyword. The source tracking engine 120 may also maintain a list of keywords that trigger determination or adjustment of the region of interest, and the list of keywords may be configured by a user via a user interface or an API.

The language model may also analyze conversational context to determine relevance of content within the video environment. For instance, the language model may identify question-and-answer exchanges, topic transitions, speaker introductions, and/or other conversational patterns that indicate content of interest. The source tracking engine 120 may utilize the conversational context to anticipate which sources of interest are likely to become active. For example, when a first speaker poses a question to a second speaker, the source tracking engine 120 may preemptively adjust tracking parameters to capture a response from the second speaker.

In some examples, the language model may be a large language model (LLM). For example, the source tracking engine 120 may utilize a LLM to perform semantic analysis of content within the video environment. The LLM may receive transcribed speech, detected text from visual content, and/or other textual inputs derived from the video environment. The LLM may generate outputs indicating relevance scores, content summaries, topic classifications, and/or recommended tracking actions based on the semantic content. The source tracking engine 120 may utilize the outputs from the LLM to dynamically adjust source tracking parameters, region of interest boundaries, and/or fencing configurations.

In some examples, the language model may be vision-language model. For example, the source tracking engine 120 may utilize a vision-language model to jointly analyze visual and textual content within the video environment. The vision-language model may receive video frames from the video stream 103 and may generate textual descriptions, object labels, activity descriptions, and/or scene interpretations. The source tracking engine 120 may utilize the outputs from the vision-language model to identify visually interesting content such as presentations, demonstrations, whiteboard content, and/or gestures that warrant focused tracking.

The source tracking engine 120 may also utilize the language model to identify content that should be excluded from capture based on semantic analysis. For instance, the language model may identify when a speaker indicates that content is not intended for capture. The source tracking engine 120 may utilize this determination to trigger generation of an exclusion region and/or to disable capture of audio and/or video associated with the speaker. The language model may also identify sensitive topics, personal information, and/or other content categories that warrant exclusion based on predefined policies.

The source tracking engine 120 may also utilize the language model to generate natural language queries for retrieving relevant information from the video environment. For instance, a user may provide a natural language query such as “focus on the person discussing the budget” or “track the person presenting slides.” The language model may interpret the natural language query and generate corresponding tracking parameters for the source tracking engine 120. This natural language interface may enable intuitive control of source tracking and/or fencing functionality.

The source tracking engine 120 may additionally utilize the sensor data 107, metadata associated with the one or more video capture devices 102, metadata associated with the one or more audio capture devices 104, metadata associated with the one or more DSP models 112, and/or metadata associated with the one or more AI models 114 to further improve accuracy of source tracking output provided by the AV processing system 108. In some examples, the source tracking engine 120 may additionally input the sensor data 107, metadata associated with the one or more video capture devices 102, metadata associated with the one or more audio capture devices 104, metadata associated with the one or more DSP models 112, and/or metadata associated with the one or more AI models 114 to the source tracking model 120 to generate the source tracking data 130.

Metadata may refer to contextual and/or technical information associated with audio data, video data, sensor data, and/or modeling data within the system 100. Metadata may comprise information regarding capture devices, processing parameters, timing information, and/or other contextual data. For example, metadata associated with the video stream 103 may comprise parameters of the one or more video capture devices 102, timestamp information, encoding information, and/or other information regarding the video stream 103. Metadata associated with the audio stream 105 may comprise sampling rate, bit depth, number of channels, microphone array configuration information, angle-of-arrival information, and/or other information regarding the audio stream 105.

Further, metadata associated with the one or more DSP models 112 may include information regarding particular DSP algorithms utilized, parameter settings, confidence scores, and/or other contextual information regarding DSP processing. Metadata associated with the one or more AI models 114 may include information regarding particular AI algorithms utilized, model parameters, confidence scores for predictions, and/or other contextual information regarding AI processing. In some examples, the source tracking model 110 may utilize metadata from multiple sources to align timing and coordinate systems across different data sources and to enhance the accuracy of source tracking predictions.

The AV processing system 108 may utilize the environment fencing engine 122 to enable fencing functionality for one or more regions in the video environment. For example, the fencing functionality may enable exclusion of audio content and/or video content from areas of the video environment outside the region of interest. The fencing functionality may include applying active noise cancellation to the areas of the video environment outside the region of interest, disabling video capture with respect to the areas of the video environment outside the region of interest, etc. In some examples, the environment fencing engine 122 may apply active noise cancellation to one or more portions of the audio stream 105 associated with a region of the environment that is different than the region of interest. In some examples, the environment fencing engine 122 may disable video capture for one or more portions of the video stream 103 associated with a region of the environment that is different than the region of interest.

In some examples, the environment fencing engine 122 may apply class-specific filtering to one or more portions of the video stream 103 and/or one or more portions of the audio stream 105 associated with a region of the environment that is different than the region of interest. The class-specific filtering may refer to a filtering technique that selectively processes, attenuates, and/or removes content based on a classification of the content. For audio content, class-specific filtering may identify and filter specific classes of audio such as background noise, keyboard typing, air conditioning sounds, and/or other audio classes while preserving speech or other desired audio content. For video content, class-specific filtering may selectively process, combine, or remove specific classes of visual content such as particular objects, individuals, or regions based on predefined criteria or real-time classification.

The environment fencing engine 122 may exclude video content from within a fencing boundary or a region of the environment that is different than the region of interest. For instance, the environment fencing engine 122 may exclude video content exclusion by selectively processing, producing, and/or mixing video content based on a determined association with the region of interest. In some examples, the environment fencing engine 122 may disable a video stream, a video channel, a video track, a user interface view, and/or another display associated with a fencing boundary or a region of the environment that is different than the region of interest. For instance, when capturing a user interface view (e.g., a video tile) for a source of interest within a region of interest via a gallery view layout presented on a display of an output device, the environment fencing engine 122 may dynamically adjust the video composition for the user interface view based on presence or absence of the sources of interest within the region of interest such that if the source of interest leaves the region of interest, the user interface view is removed from the gallery view layout.

The environment fencing engine 122 may also manage multiple output video streams, where each source of interest corresponds to a separate video stream. Additionally, in response to a determination that a source of interest leaves the region of interest, the environment fencing engine 122 may stop output of the corresponding video stream. For example, if three sources of interest are present within the region of interest, the environment fencing engine 122 may split a composited video into three horizontal tiles across a high-resolution video frame, such as a 4K video frame. If one source of interest leaves the region of interest, the environment fencing engine 122 may reconfigure the video composition to include only two horizontal tiles. In some examples, the environment fencing engine 122 may utilize the location information of sources of interest to inform subsequent determinations and/or adjustments to video fencing functionality.

The environment fencing engine 122 may enable improved audio-visual isolation within the video environment. For example, by utilizing the environment fencing engine 122, the AV processing system 108 may create virtual boundaries for the video environment that effectively partition the video environment into distinct zones of capture and exclusion for audio content and/or video content. In contrast to simple area-based filtering of audio content, the fencing enabled by the environment fencing engine 122 may utilize intelligent, context-aware processing of both audio and video streams. For audio content, active noise cancellation applied to areas outside the region of interest may include adaptive filtering that dynamically adjusts to changing acoustic conditions, ensuring that unwanted sounds are effectively suppressed without degrading the quality of desired audio within the region of interest. In some examples, the environment fencing engine 122 may utilize spectral subtraction, multi-channel Wiener filtering, or machine learning-based approaches for active noise cancellation.

To disable capture for portions of a video stream outside the region of interest, the environment fencing engine 122 may utilize selective pixel masking where pixels corresponding to excluded areas are set to a neutral value or completely removed from the video stream. In some examples, the environment fencing engine 122 may utilize one or more computer vision techniques to identify and remove specific audio sources from the video stream in real-time while maintaining the integrity of the desired video content. In some examples, the environment fencing engine 122 may dynamically adjust fencing boundaries to ensure continuous, high-quality capture of relevant content while maintaining privacy and focus by excluding certain audio content and/or video content.

The environment fencing engine 122 may also utilize class-specific filtering audio and/or video. In some examples, the environment fencing engine 122 may utilize an AI model trained to recognize and/or selectively filter specific classes of audio content and/or visual content. For instance, with audio, the environment fencing engine 122 may identify and remove specific types of background noises (e.g., keyboard typing, air conditioning hum) while preserving speech. With video, the environment fencing engine 122 may selectively remove or blur certain classes of objects or individuals based on predefined criteria. The environment fencing engine 122 may also disable video capture associated with a particular area outside the fencing.

In some examples, the environment fencing engine 122 may determine that a source of interest visible on a display and/or audible from loudspeakers within the video environment corresponds to a region to avoid for audio capture and/or video capture. For instance, the environment fencing engine 122 may distinguish between a person physically present in the video environment and a person visible on a display device such as a television, monitor, or projection screen. The environment fencing engine 122 may utilize the one or more AI models 114 to detect one or more display devices within the video environment. Further, the environment fencing engine 122 may automatically generate exclusion regions corresponding to the detected display devices. This enables the AV processing system 108 to focus capture on physically present sources of interest while excluding reproduced video content from remote participants or media playback.

The environment fencing engine 122 may also distinguish between audio from a physically present source of interest and audio reproduced by loudspeakers within the video environment. For instance, the environment fencing engine 122 may identify loudspeaker locations based on known room configurations, sensor data 107, and/or acoustic analysis of the audio stream 105. The environment fencing engine 122 may therefore generate exclusion regions corresponding to the identified loudspeaker locations to prevent capture of reproduced audio. Further, the AV processing system 108 may utilize beamforming techniques to steer nulls toward loudspeaker locations while maintaining capture from physically present sources of interest. This enables the AV processing system 108 to avoid feedback loops, echo artifacts, and/or unintended capture of remote participant audio in video conferencing scenarios.

The environment fencing engine 122 may also utilize spatial information to distinguish between ceiling-mounted loudspeakers, wall-mounted loudspeakers, and/or floor-level audio sources. For instance, the environment fencing engine 122 may determine that audio sources located at ceiling height or along walls correspond to loudspeakers rather than physically present sources of interest. The environment fencing engine 122 may utilize depth information from the sensor data 107, the video stream 103, and/or the audio stream 105 to estimate vertical positions of audio sources within the video environment. Based on the estimated positions, the environment fencing engine 122 may selectively exclude audio from loudspeaker locations while preserving audio from floor-level sources of interest.

In some examples, the video environment may be configured for podcast production. As such, the AV processing system 108 may be configured with tracking, fencing, and/or capture functionality specially configured for podcast recording scenarios. For instance, the AV processing system 108 may utilize predefined podcast configurations that specify regions of interest corresponding to host and guest seating positions, exclusion regions corresponding to production equipment and crew areas, and/or capture parameters optimized for speech intelligibility and audio quality. The AV processing system 108 may also utilize the one or more AI models 114 to identify podcast-specific activities such as microphone adjustments, script reading, conversational turn-taking, and/or other podcast-specific activities to dynamically adjust tracking and fencing parameters.

The AV processing system 108 may also utilize podcast-specific mixing protocols to configure audio capture for podcast production. For instance, the AV processing system 108 may automatically adjust beamforming parameters to focus on active speakers, apply noise reduction to minimize background sounds, and/or balance audio levels between multiple participants. The AV processing system 108 may also utilize the source tracking data 130 to enable automatic camera switching between podcast participants based on speaking activity. Additionally, the AV processing system 108 may be communicatively coupled to or integrated with a podcast production system to enable synchronized capture and mixing of audio and video content for podcast distribution.

This granular level of control over audio and video content may enable the AV processing system 108 to create highly customized and context-appropriate capture areas within the video environment. This also enables scenarios where certain types of content are preserved or excluded based on relevance to real-time actions in the video environment, rather than solely on their spatial location within the video environment. This flexibility is particularly valuable in complex, multi-purpose spaces where sources of interest may change dynamically based on the current activity within the video environment.

The source tracking engine 120 may also determine location information for the source of interest based on the source tracking data 130. The location information may represent processed and/or refined location data for the source of interest within the video environment. For example, the location information may indicate a tracked location of the source of interest within the video environment. The location information may include a set of coordinates with respect to an audio capture device (e.g., a microphone array) of the one or more audio capture devices 104 that captured at least a portion of audio for the source of interest. For example, the location information may include Cartesian coordinates (e.g., X, Y, and Z coordinates) and/or spherical coordinates (e.g., radial distance, Azimuth angle, and elevation angle) that identify the source of interest within the video environment.

The Cartesian coordinates and/or the spherical coordinates may represent a location of the source of interest in real time with respect to capture of the audio stream 105. For example, in the context of audio source localization and tracking, the Cartesian coordinates and/or the spherical coordinates may be utilized to describe the position of source of interest relative to the audio capture device. The Cartesian coordinates may represent points in space using a set of numerical coordinates that measure the distance of the point from perpendicular reference axes. The spherical coordinates may provide a 3D representation of a location in space relative to a fixed origin.

The source tracking engine 120 may also manage an identity object list for the video environment based on the source tracking data 130. The identity object list may be a data structure that maintains tracking and identification information for respective sources of interest within the video environment. Additionally, the identity object list may be managed by the source tracking engine 120 based on the source tracking data 130. The identity object list may include a list of unique identifiers where each unique identifier corresponds to a particular source of interest associated with the video environment to enable identification and/or tracking of the particular source of interest.

In some examples, the identity object list may store, for each source of interest, one or more of: a unique identifier, one or more associated embeddings such as feature embeddings or appearance embeddings, a tracking history including previous positions and trajectories, confidence scores associated with identification and/or tracking, timestamps indicating when the source of interest was first detected and last observed, and/or metadata describing characteristics of the source of interest.

The identity object list may also be dynamically updated by the source tracking engine 120 to add new entries when new sources of interest are detected, update existing entries based on new observations from the source tracking data 130, and/or remove entries when sources of interest are no longer present in the video environment. Further, the unique identifier may be correlated to a particular region of interest of the video environment. The identity object list may enable the source tracking engine 120 to maintain persistent identity assignments for sources of interest over time, re-identify sources of interest that temporarily leave and re-enter the region of interest, and/or distinguish between different sources of interest within the video environment.

The source tracking data 130 may be provided to one or more downstream devices and/or one or more downstream systems. For instance, the source tracking engine 120 may output the source tracking data 130 to an output device. The output device may include one or more of: a speaker, a speaker array, headphones, earphones, a video capture device (e.g., a camera), a codec (e.g., coder-decoder) device, an audio mixer device, a smartphone, a tablet computer, a laptop, a personal computer, an audio workstation device, a wearable device, an augmented reality device, a virtual reality device, a broadcasting device, a recording device, a haptic device, or another type of output device. In some examples, the output device is an output device communicatively coupled to the microphone array that captures the audio stream 105.

In some examples, the source tracking engine 120 may output the source tracking data 130, an indication of the region of interest, the location information, and/or the identity object list to the output device. In some examples, the source tracking engine 120 may output the source tracking data 130, an indication of the region of interest, the location information, and/or the identity object list to a camera device. For instance, the source tracking engine 120 may transmit the source tracking data 130, an indication of the region of interest, the location information, and/or the identity object list to a camera control system of the camera device to enable control of the camera device based on the location information.

The source tracking engine 120 may also enable control of the camera device to modify camera framing based on the source tracking engine 120 may output the source tracking data 130, an indication of the region of interest, the location information, and/or the identity object list. The camera control system may be a system or subsystem configured to control operational parameters of a video capture device. For example, the camera control system may control parameters such as pan, tilt, zoom, focus, exposure, framing, motion, and/or other camera settings. The camera control system may receive control signals, source tracking data, and/or other input to adjust the operational parameters of the video capture device in response to changes in the video environment.

In some examples, the output device may utilize the source tracking data 130, an indication of the region of interest, the location information, and/or the identity object list for one or more audio processing applications such as, but not limited to: beamforming and/or spatial filtering to enhance audio capture from specific directions, acoustic echo cancellation with improved source localization, noise reduction by focusing beamforming on desired audio sources, automatic camera steering in a video conferencing system for improved audio capture for video data, spatial audio rendering for immersive sound reproduction, sound source separation for complex acoustic scenes, adaptive gain control based on source distance and direction, room acoustics analysis and environmental mapping, and/or one or more other types of audio processing applications. In some examples, the source tracking data 130, an indication of the region of interest, the location information, and/or the identity object list may be utilized to generate audio output data. The audio output data may include: an audio stream, a video stream, broadcast audio, broadcast video, speech reinforcement audio, and/or other audio output data.

The audio output data may be an enhanced version of the audio stream 105 to enable desirable and/or appropriately processed audio for the audio environment. In some examples, the audio output data includes beamformed audio data that is digitally processed to enhance audio of the audio stream 105. In some examples, the output device may perform audio processing based on the source tracking data 130, an indication of the region of interest, the location information, and/or the identity object list to amplify, equalize, filter, and/or otherwise enhance the audio stream 105. In some examples, the output device may perform denoising, dereverberation, speech shaping, artifacts reduction, acoustic echo cancellation (AEC), and/or other audio processing with respect to the audio stream 105.

The output device may utilize the source tracking data 130, an indication of the region of interest, the location information, and/or the identity object list for one or more video processing applications such as, but not limited to: individual framing for video conferencing, generating input data (e.g., a cropped face) for an AI model, providing audio source separation for video data, selecting an optimal video capture device in an audio environment, automatic camera framing to focus on active speakers, dynamic adjustment of camera zoom levels based on speaker distance, intelligent switching between multiple cameras to capture different participants, facial recognition and tracking of speakers, gesture recognition for non-verbal communication cues, augmented reality overlays positioned relative to speaker locations, automatic generation of speaker name tags or labels in video feeds, optimization of video encoding parameters based on areas of interest, creation of virtual camera views for improved meeting layouts, automatic adjustment of lighting or exposure settings to enhance visibility of active speakers, generation of speaker-focused picture-in-picture views, spatial audio rendering aligned with video positioning, real-time video composition for optimal display of multiple participants in large group settings, creating a 3D model of an audio environment, and/or one or more other types of video processing applications.

In some examples, the source tracking data 130, an indication of the region of interest, the location information, and/or the identity object list may be included in control data (e.g., one or more control signals) for the output device to configure and/or control the output device. For instance, the control data that includes the source tracking data 130, an indication of the region of interest, the location information, and/or the identity object list may be utilized to control and/or configure one or more portions of the output device.

The control data may include one or more configuration parameters (e.g., a configuration parameter set) configured based on the source tracking data 130, an indication of the region of interest, the location information, and/or the identity object list. In some examples, the one or more configuration parameters include a configuration parameter such as, but not limited to one or more: a camera setting, camera selection, camera focus direction, pan, zoom, crop, microphone array settings, a beam steering setting, a video encoding setting, a video frame transmission setting, video frame size, frame rate, color depth settings, resolution format settings, and/or another type of configuration parameter for the output device.

An output device may also modify video framing of the output device based on the source tracking data 130, an indication of the region of interest, the location information, and/or the identity object list. Modification of the video framing may alter a position of visual data associated with a source of interest in one or more video frames. In some examples, the output device may utilize the control data to modify the video framing. In some examples, the output device may utilize the control data to steer a microphone array beam for the one or more audio capture devices 104. In some examples, the control data may enable or disable one or more functionalities associated with the output device. For instance, the control data may include one or more control signals and/or configuration data to enable or disable one or more video processing tasks. A video processing task may include camera data acquisition, video encoding/decoding, video machine learning modeling, or another type of video processing task. In some examples, the control data may be utilized to initiate feature extraction with respect to video data, configure parameters or types of features to be extracted, etc.

In some examples, the video pipeline engine 124 may extract raw video data from the video stream 103 to enable the source tracking modeling provided by the source tracking model 110. The video pipeline engine 124 may also utilize the source tracking data 130, an indication of the region of interest, the location information, and/or the identity object list to generate encoded video data. The encoded video data may be an encoded version of the video stream 103. Further, the video pipeline engine 124 may utilize the source tracking data 130, an indication of the region of interest, the location information, and/or the identity object list to enable tracking across multiple video capture devices 102.

The video pipeline engine 124 may output the encoded video data to a network device. The network device may be a network switch, a user device, a display device, an edge device, or another type of device communicatively coupled to the system 100 via a network. The network may be a communication network or any suitable network or combination of networks that supports any appropriate protocol suitable for communication of the encoded video data to and from devices. For example, the network may utilize a network communication protocol such as IP, IPoE, or other network communication protocol to transmit the encoded video data via IP datagrams. In some examples, the network may transmit the encoded video data via one or more network layers such as a data link layer. In some examples, the encoded video data may be encapsulated according to a network communication protocol to provide encapsulated video data packets. In some examples, the network is implemented as the Internet, a wireless network, a wired network (e.g., Ethernet), a local area network (LAN), a Wide Area Network (WANs), Bluetooth, Near Field Communication (NFC), or any other type of network that provides communications between one or more components of a network architecture.

In some examples, the video pipeline engine 124 may generate a 3D model of the video environment based on the source tracking data 130, an indication of the region of interest, the location information, and/or the identity object list. The 3D model may include 3D model data associated with visual attributes of the video environment. The 3D model data may include data related to 3D positions, viewing directions, color data, density data, camera pose data, and/or other visual attributes of the audio environment. In some examples, the 3D model may include point cloud locations, voxel grid locations, mesh locations, or other 3D representative locations of the video environment.

The audio pipeline engine 126 may also extract raw audio data from the audio stream 105 to enable the source tracking modeling provided by the source tracking model 110. The audio pipeline engine 126 may also utilize the source tracking data 130, an indication of the region of interest, the location information, and/or the identity object list to generate enhanced audio data. The enhanced audio data may be associated with denoising, dereverberation, source separation, and/or otherwise processed as compared to the audio stream 105. In some examples, the audio pipeline engine 126 outputs the enhanced audio data to a network device. The network device may be a network switch, a user device, a display device, an edge device, or another type of device communicatively coupled to the system 100 via a network.

Additionally, one or more beamformed lobes of a microphone array may be steered based on the source tracking data 130. The steering of the one or more beamformed lobes may be realized by modifying one or more adaptive beamforming algorithms, such as an MVDR algorithm, a delay and sum beamforming algorithm, a Linearly Constrained Minimum Variance (LCMV) algorithm, or another type of adaptive beamforming algorithm utilized by the microphone array. In some examples, an adaptive beamforming algorithm for a microphone array may be dynamically adjusted using real-time position information provided by the source tracking data 130. The microphone array may also utilize null-steering based on the source tracking data 130 to actively suppress interference from known noise sources or excluded regions to further enhance selectivity of audio capture associated with the audio stream 105. In some examples, the microphone array may utilize frequency-dependent steering based on the source tracking data 130 to enable optimal capture of speech via the audio stream 105.

Confidence scores associated with the source tracking data 130 may also be utilized to apply a weight to one or more beamforming parameters for the microphone array to emphasize audio capture for desirable sources of interest. In some examples, steering of the one or more beamformed lobes based on source tracking data 130 may further enable enhanced audio quality, reduced background noise, and/or improved speaker separation for the audio stream 105. One or more new beamforming lobes of the microphone array may be deployed or in a direction of a source of interest based on the source tracking data 130. Additionally, one or more beamforming lobes of the microphone array may be disengaged with respect to an undesirable audio source in the video environment based on the source tracking data 130.

Accordingly, the AV processing system 104 may provide improved video processing as compared to traditional video processing techniques. The AV processing system 104 may provide improved audio for the video environment. For example, encoded video data may be provided with improved accuracy of localization of a sound source in the video environment. The encoded video data may also be provided with improved audio signals with reduced noise, reverberation, and/or other undesirable audio artifacts even in view of exacting video latency requirements for the encoded video data. For example, the AV processing system 104 may remove or suppress undesirable noise for predefined noise locations in the video environment to provide the encoded video data.

The AV processing system 104 may also employ fewer computing resources when compared to traditional video processing systems that are used for video processing. The AV processing system 104 may also be configured to deploy a smaller number of memory resources allocated to video processing, beamforming, source separation, denoising, dereverberation, and/or other audio processing for the encoded video data. In some examples, the AV processing system 104 may be configured to improve processing speed of video processing operations, beamforming operations, source separation operations, denoising operations, dereverberation operations, and/or audio filtering operations. These improvements may enable an improved AV processing systems to be deployed with respect to cameras, microphones or other hardware/software configurations where processing and memory resources are limited, and/or where processing speed and efficiency is important.

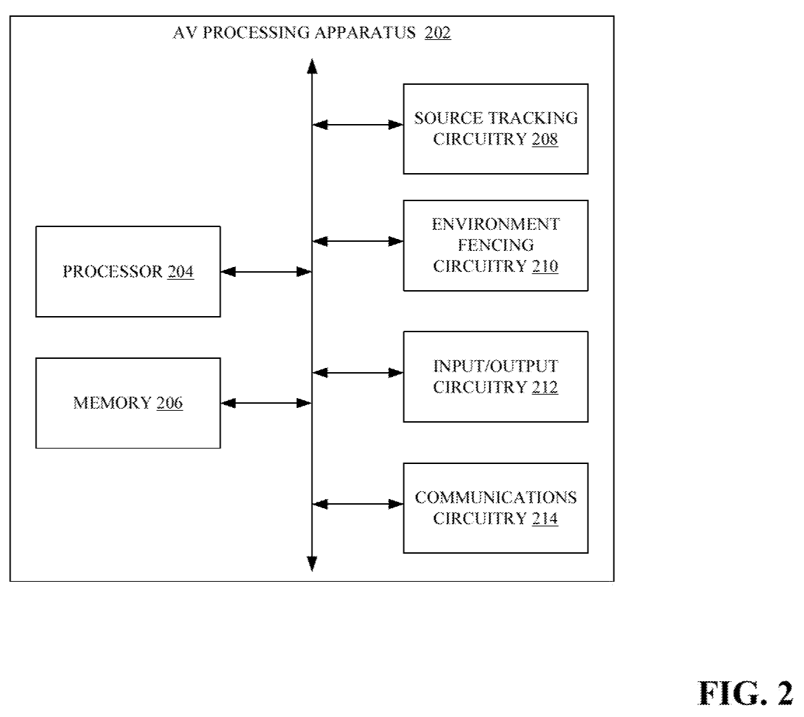

FIG. 2 illustrates an example AV processing apparatus 202 configured in accordance with one or more embodiments of the present disclosure. The AV processing apparatus 202 may be configured to perform one or more techniques described in FIG. 1 and/or one or more other techniques described herein.

The AV processing apparatus 202 may be a computing system communicatively coupled with one or more circuit modules related to audio processing. The AV processing apparatus 202 may comprise or otherwise be in communication with a processor 204, a memory 206, source tracking circuitry 208, environment fencing circuitry 210, input/output circuitry 212, and/or communications circuitry 214. In some examples, the processor 204 (which may comprise multiple or co-processors or any other processing circuitry associated with the processor) may be in communication with the memory 206.

The memory 206 may comprise non-transitory memory circuitry and may comprise one or more volatile and/or non-volatile memories. In some examples, the memory 206 may be an electronic storage device (e.g., a computer readable storage medium) configured to store data that may be retrievable by the processor 204. In some examples, the data stored in the memory 206 may comprise audio data, stereo audio signal data, mono audio signal data, radio frequency signal data, SRP transformation data, a set of SRP weights, or the like, for enabling the AV processing apparatus 202 to carry out various functions or methods in accordance with embodiments of the present disclosure, described herein.

In some examples, the processor 204 may be embodied in a number of different ways. For example, the processor 204 may be embodied as one or more of various hardware processing means such as a central processing unit (CPU), a microprocessor, a coprocessor, a DSP, a field programmable gate array (FPGA), a neural processing unit (NPU), a GPU, a system on chip (SoC), a cloud server processing element, a controller, or a processing element with or without an accompanying DSP. The processor 204 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some examples, the processor 204 may comprise one or more processing cores configured to perform independently. A multi-core processor may enable multiprocessing within a single physical package. Additionally or alternatively, the processor 204 may comprise one or more processors configured in tandem via a bus to enable independent execution of instructions, pipelining, and/or multithreading. In some examples, the processor 204 may be an audio conferencing processor.

In some examples, the processor 204 may be configured to execute instructions, such as computer program code or instructions, stored in the memory 206 or otherwise accessible to the processor 204. Alternatively or additionally, the processor 204 may be configured to execute hard-coded functionality. As such, whether configured by hardware or software instructions, or by a combination thereof, the processor 204 may represent a computing entity (e.g., physically embodied in circuitry) configured to perform operations according to an example of the present disclosure described herein. For example, when the processor 204 is embodied as a CPU, DSP, ARM, FPGA, ASIC, or similar, the processor may be configured as hardware for conducting the operations of an example of the disclosure. Alternatively, when the processor 204 is embodied to execute software or computer program instructions, the instructions may specifically configure the processor 204 to perform the algorithms and/or operations described herein when the instructions are executed. However, in some examples, the processor 204 may be a processor of a device specifically configured to employ an example of the present disclosure by further configuration of the processor using instructions for performing the algorithms and/or operations described herein. The processor 204 may further comprise a clock, an arithmetic logic unit (ALU) and logic gates configured to support operation of the processor 204, among other things.

In one or more examples, the AV processing apparatus 202 may comprise the source tracking circuitry 208. The source tracking circuitry 208 may be any means embodied in either hardware or a combination of hardware and software that is configured to perform one or more functions disclosed herein related to the source tracking engine 120. In one or more examples, the AV processing apparatus 202 may comprise the environment fencing circuitry 210. The environment fencing circuitry 210 may be any means embodied in either hardware or a combination of hardware and software that is configured to perform one or more functions disclosed herein related to the environment fencing engine 122.

In some examples, the AV processing apparatus 202 may comprise the input/output circuitry 212 that may, in turn, be in communication with processor 204 to provide output to the user and, in some examples, to receive an indication of a user input. The input/output circuitry 212 may comprise a user interface and may comprise a display. In some examples, the input/output circuitry 212 may also comprise a keyboard, a touch screen, touch areas, soft keys, buttons, knobs, or other input/output mechanisms.

In some examples, the AV processing apparatus 202 may comprise the communications circuitry 214. The communications circuitry 214 may be any means embodied in either hardware or a combination of hardware and software that is configured to receive and/or transmit data from/to a network and/or any other device or module in communication with the AV processing apparatus 202. In this regard, the communications circuitry 214 may comprise, for example, an antennae or one or more other communication devices for enabling communications with a wired or wireless communication network. For example, the communications circuitry 214 may comprise antennae, one or more network interface cards, buses, switches, routers, modems, and supporting hardware and/or software, or any other device suitable for enabling communications via a network. Additionally or alternatively, the communications circuitry 214 may comprise the circuitry for interacting with the antenna/antennae to cause transmission of signals via the antenna/antennae or to handle receipt of signals received via the antenna/antennae. In some examples, the communications circuitry 214 may be any means embodied in either hardware or a combination of hardware and software that is configured to perform one or more functions disclosed herein related to the video pipeline engine 124 and/or the audio pipeline engine 126.

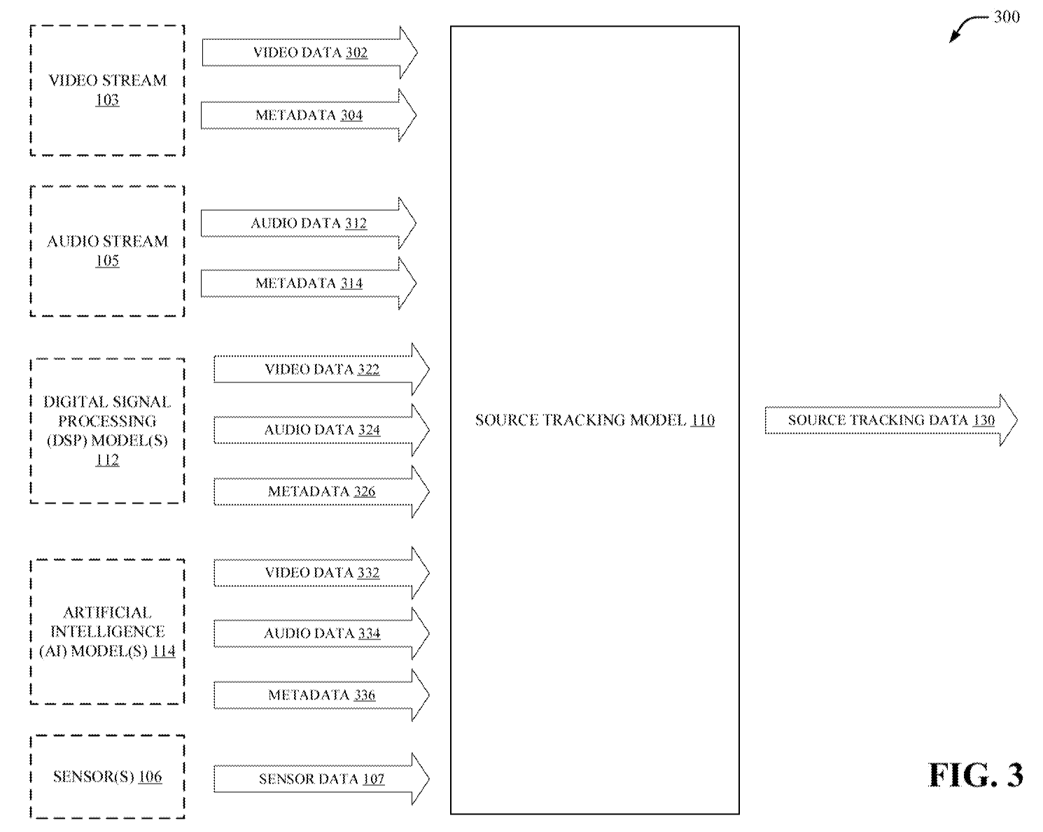

FIG. 3 illustrates a system 300 associated with source tracking modeling according to one or more embodiments of the present disclosure. The system 300 includes the source tracking model 110. The tracking system 300 includes multiple input sources and/or models that provide data to the source tracking model 110. Based on the data provided by the multiple input sources and/or models, the source tracking model 110 may output the source tracking data 130. As illustrated in FIG. 3, the multiple input sources and/or models include the video stream 103, the audio stream 105, the one or more DSP models 112, the one or more AI models 114, and/or the one or more sensors 106.

The source tracking model 110 may receive one or more inputs including: video data 302 and/or metadata 304 from the video stream 103; audio data 312 and/or metadata 314 from the audio stream 105; video data 322, audio data 324, and/or metadata 326 from the one or more DSP models 112; video data 332, audio data 334, and/or metadata 326 from AI models 114; and/or sensor data 107 from the one or more sensors 106.

The source tracking model 110 may process one or more of the inputs based on one or more source tracking modeling techniques. For example, the source tracking engine 120 may apply the source tracking model 110 to the video data 302, the metadata 304, the audio data 312, the metadata 314, the video data 322, the audio data 324, the metadata 326, the video data 332, the audio data 334, the metadata 326, and/or the sensor data 107 to generate the source tracking data 130.

The video data 302 may include raw or minimally processed visual information extracted from the video stream 103. In some examples, the video data 302 includes a sequence of digital video frames respectively including pixel values that encode color information and/or brightness information. For instance, the video data 302 may include video frame data for a particular video frame (e.g., a 1920x1080 resolution video frame at 30 frames per second, etc.) where each pixel is represented by a particular YUV value. In some examples, the video data 302 may include luma information and/or chroma information for one or more video frames of the video stream 103. For instance, the video data 302 may include down-sampled video frame information, such as the Y channel of YUV format frames. In some examples, the video data 302 may include information regarding a video compression technique and/or encoding technique for one or more video frames of the video stream 103. For instance, the video data 302 may include information associated with H.264, MJPEG, NV12, NV21, YUV, YUV2, or another type of video compression technique associated with one or more video frames of the video stream 103.

The metadata 304 may include contextual and/or technical information regarding the video stream 103. The metadata 304 may include extrinsic parameters and/or intrinsic parameters of a video capture device 102. The intrinsic parameters may describe internal characteristics of the one or more video capture devices 102 such as focal length, sensor size, field of view, image center, and/or one or more intrinsic parameters associated with the one or more video capture devices 102.

The extrinsic parameters may describe a position and/or orientation of the one or more video capture devices 102 within the video environment. For example, the metadata 304 may include data such as, but not limited to: timestamp information, one or more camera parameters (e.g., focal length, field of view, sensor size, image center, etc.) for a video capture device 102, encoding information (e.g., codec, bitrate, video compression format, etc.), an average brightness or other quality determinations for a video frame, keyframe intervals, color space information, global positioning system (GPS) coordinates of a video capture device 102, position information such as x/y/z position information for a video capture device 102 within the video environment, orientation data for a video capture device 102, sensor specifications for a video capture device 102, optical parameters for a video capture device 102, lens distortion correction information for a video capture device 102, image quality (IQ) settings for a video capture device 102, electronic pan-tilt-zoom (ePTZ) coordinates for a video capture device 102, auto-framing coordinates for a video capture device 102, depth map information, object detection information provided by a video capture device 102, other metadata associated with the video stream 103, and/or other metadata associated with a video capture device 102.

In some examples, the ePTZ or auto-framing coordinates may be particularly useful when the video stream 103 represents only a portion of a wider field of view captured by the video capture device 102. In some examples, depth information may be estimated based on one or more data streams associated with a camera, microphone, and/or video stream. The source tracking model 110 may utilize this additional metadata to enhance the accuracy and context of source tracking predictions, thereby improving the overall performance of the dynamic audio-video tracking and/or fencing functionality provided by the AV processing system 108.

The audio data 312 may include raw or minimally processed audio information extracted from the audio stream 105. In some examples, the audio data 312 includes a series of amplitude values sampled at defined intervals. For instance, the audio data 312 may include 16-bit samples captured at 44,100 times per second. The metadata 314 may include contextual and/or technical information regarding the audio stream 105. For example, the metadata 314 may include data such as, but not limited to: sampling rate, bit depth, number of channels, microphone array configuration information, raw detection information from an external system or audio capture devices 104 with internal digital signal processing functionality, angle-of-arrival information provided by a microphone array, voice information associated with an audio source, noise information associated with an audio source, audio classification information, and/or other metadata associated with the audio stream 105.

In some examples, the metadata 314 may comprise a voice classification and/or a noise classification provided by an AI model. The metadata 314 may also comprise reverberation information (e.g., room reverberation information) associated with the environment. The voice classification may refer to a classification of audio content that identifies the audio content as human speech or voice. The voice classification may distinguish between speech from different speakers, identify characteristics of speech such as gender or age, and/or classify speech based on other acoustic properties. The noise classification may refer to a classification of audio content that identifies the audio content as noise or a particular type of noise. The noise classification may distinguish between different types of noise such as background noise, environmental noise, mechanical noise, and/or other noise categories. The noise classification may also be utilized to determine whether audio content should be filtered, attenuated, or excluded from processing by the source tracking model 110.

The video data 322 may include video modeling information generated by the one or more DSP models 112. In some examples, the video data 322 includes video modeling information associated with edge detection, motion estimation, feature extraction, frequency domain transformations, histogram analysis, and/or other video modeling information associated with the one or more DSP models 112. For instance, the video data 322 may include a list of detected edges or corners in respective video frames, motion vectors describing movement of sources of interest between video frames, and/or other video modeling information associated with the one or more DSP models 112. The audio data 324 may include audio modeling information generated by the one or more DSP models 112.

In some examples, the audio data 324 includes audio modeling information associated with frequency domain representations, MFCCs, direction of arrival estimates for sources of interest, spectrogram representation, voice information associated with an audio source, noise information associated with an audio source, audio classification information, audio localization data, raw angle of arrival detections of audio, and/or other audio modeling information associated with the one or more DSP models 112. The audio localization data may include, but is not limited to: time difference of arrival (TDOA) information representative of the relative timing differences of audio signals reaching different microphones in a microphone array, angle of arrival information representative of a direction from which an audio signal arrives at a receiver or sensor array of a microphone array, azimuth and elevation angle estimates representative of the horizontal and vertical angular positions of sources of interest relative to a microphone array, initial coordinate estimates for a source of interest representative of approximate spatial locations of detected sources of interest, confidence metrics associated with the estimated locations, probability distributions associated with the estimated locations, and/or other audio localization data.

The audio data 312 may include various types of raw audio information captured by the audio capture device 104. For instance, the audio data 312 may include audio samples at different sampling rates (e.g., 44.1 kHz, 48 kHz, 96 kHz, etc.) and/or different bit depths (e.g., 16-bit, 24-bit, 32-bit, etc.). In some examples, the audio data 312 may include audio compression information and/or audio encoding information associated with an audio compression format. In some examples, the audio data 312 may include audio streaming information associated with an audio streaming standard such as an audio over IP (AoIP) and/or audio over Ethernet (AoE) standard.

The audio data 324 may include additional audio modeling information generated by the one or more DSP models 112. For instance, the audio data 324 may include audio modeling information associated with voice/noise classification, speech amplitude data, and/or room reverberation information. The voice/noise classification may provide insights into the nature of audio sources within the video environment to enable distinguishing between human speech and other types of audio events. Speech amplitude data may provide information regarding the intensity or volume of speech from sources of interest which may be utilized for source localization or prioritization. Room reverberation information may provide context about the acoustic properties of the video environment to enhance the accuracy of direction of arrival estimates or other audio localization techniques

The metadata 326 may include contextual and/or technical information regarding the one or more DSP models 112. In some examples, the metadata 326 includes information regarding a particular DSP algorithm utilized to generate at least a portion of the video data 322 and/or the audio data 324, parameter settings for the one or more DSP models 112, confidence scores for output provided by the one or more DSP models 112, microphone array information, information regarding a direction of arrival algorithm associated with the one or more DSP models 112, weighting coefficients associated with the one or more DSP models 112, windowing functions associated with the one or more DSP models 112, and/or other metadata associated with the one or more DSP models 112. For instance, the metadata 326 may indicate that a particular edge detection algorithm was utilized with certain threshold settings to determine edge detection information associated with the video data 322. In some examples, the source tracking model 110 may utilize DSP modeling information to enhance the accuracy and context of source tracking predictions.

The metadata 326 may include additional contextual and/or technical information regarding estimates or transformations of detections from the perspective of the video capture device 102 in 3D coordinates. In some examples, the information may be derived from a combination of camera intrinsic parameters, extrinsic parameters, and/or lens distortion correction data. In some examples, the one or more DSP models 112 may utilize projective geometry techniques to generate the 3D coordinate estimates. For example, given an assumption about the size of an object (e.g., a person) and the camera parameters, the one or more DSP models 112 may estimate the distance of the object from the video capture device 102. The metadata 326 may additionally include the distance estimates which may be utilized by the source tracking model 110 to enhance the accuracy of source tracking predictions.

The video data 332 may include video AI information generated by the one or more AI models 114. In some examples, the video data 332 includes video AI information associated with object recognition, facial detection and recognition, activity classification, depth estimation outputs such as depth maps or object-specific depth values, raw detection data from video (e.g., raw key points and bounding boxes), and/or other video AI information associated with the one or more AI models 114. For instance, the video data 332 may include a list of identified objects in respective video frames, bounding box information for respective video frames, key points for respective video frames, and/or class labels for respective video frames.

The audio data 334 may include audio AI information generated by the one or more AI models 114. In some examples, the audio data 334 includes speaker identification information, speech recognition information, audio event detection information, and/or other audio AI information associated with the one or more AI models 114. For instance, the audio data 334 may include transcribed speech segments associated with speaker labels or a classification of detected audio events.

The metadata 336 may include contextual and/or technical information regarding the one or more AI models 114. In some examples, the metadata 336 includes information regarding a particular AI algorithm utilized to generate at least a portion of the video data 332 and/or the audio data 334, parameters or weights for the one or more AI models 114, confidence scores for predictions provided by the one or more AI models 114, model type, model version, detection targets, training dataset information, performance metrics associated with the one or more AI models 114, bounding box information, pixel classifications, detection information, event classifications, timing information, and/or other metadata associated with the one or more AI models 114. For instance, the metadata 336 may indicate that a particular pre-trained AI model was utilized for object detection with certain confidence thresholds associated with the video data 332.

In some examples, the one or more AI models 114 may include an object detector that generates bounding box information, segmentation algorithms that classify individual pixels (e.g., labeling pixels as "person" or "table"). In some examples, the one or more AI models 114 may include activity detector that provides detection information, event classifications, timing data, and confidence scores. As such, the metadata 336 may include specific information about these AI model types and/or respective outputs. For example, the metadata 336 may indicate that a particular segmentation algorithm was utilized to classify each pixel in the video frames or that an activity detector was employed to identify specific events within the video environment.

The metadata 336 may include information regarding an AI model configured to estimate depth within the video environment. For example, the metadata 336 may include depth information on a per-pixel basis, a depth map basis, or a per-object basis (e.g., estimating that a person is X meters away from the video capture device 102). In some examples, the metadata 336 may include information regarding intrinsic and/or extrinsic camera parameters associated with a depth estimation.

The sensor data 107 may include sensor information associated with the one or more sensors 106. For example, the sensor data may include motion sensor data, proximity sensor data, radar sensor data, LiDAR sensor data, millimeter wave sensor data, TOF sensor data, and/or other sensor data associated with the video environment.

The source tracking model 110 may utilize one or more source tracking modeling techniques to process the video data 302, the metadata 304, the audio data 312, the metadata 314, the video data 322, the audio data 324, the metadata 326, the video data 332, the audio data 334, the metadata 326, and/or the sensor data 107. In some examples, the source tracking model 110 may initialize source tracking using the video data 302 and/or the video data 332 to detect an initial position of a source of interest through object detection and facial recognition techniques. In some examples, the source tracking model 110 may utilize the audio data 312 and/or the audio data 334 to identify a location of the source of interest via sound source localization. In some examples, the source tracking model 110 may correlate video and audio sources to determine an initial source tracking prediction.

The source tracking model 110 may also update visual tracking by employing the video data 322 for motion estimation between frames, applying Kalman filtering to predict new positions of tracked sources, and/or updating predicted positions using the video data 302 and/or the video data 332 for object detection and recognition. In some examples, the source tracking model 110 may update audio tracking based on the audio data 324 for direction of arrival estimation. In some examples, the source tracking model 110 may update audio source positions through beamforming techniques with respect to the audio data 312. In some examples, the source tracking model 110 may identify an active speaker using speech recognition results included in the audio data 334. In some examples, the source tracking model 110 may utilize the sensor data 107 to refine position estimates.

In some examples, the source tracking model 110 may utilize the metadata 304, the metadata 314, the metadata 326, and/or the metadata 336 to align timing and coordinate systems across different data sources. The source tracking model 110 may also correlate updated visual and audio tracking using spatial and temporal proximity, resolving conflicts with confidence scores from the metadata 326 and/or the metadata 336. In some examples, the source tracking model 110 may utilize the metadata 326 and/or the metadata 336 to dynamically adjust parameters based on real-time environmental conditions and/or processing results for the video environment.

The source tracking data 130 may include tracking information for one or more source of interest in the video environment. In some examples, the source tracking data 130 may include a unique identifier, a 3D position, a velocity vector, a confidence score, identify content, and/or associated metadata for respective tracked sources of interest. The source tracking data 130 may also include temporal information such as timestamps for each tracked position to enable reconstruction of movement trajectories over time. In some examples, the source tracking data 130 may include size or bounding box information for visual sources, audio characteristics such as frequency range or volume for audio sources, and/or predicted future positions based on current trajectories.

The source tracking data 130 may also include information regarding an interaction between a first source of interest and a second source of interest within the video environment, such as proximity to other tracked sources of interest. For a particular source of interest such as a speaker, the source tracking data 130 may include synchronization information between visual and audio tracking information. In some examples, a confidence score may be provided for different aspects of tracking (e.g., position confidence, identity confidence, etc.). In some examples, the source tracking data 130 includes historical tracking information for a source of interest to enable analysis of patterns or behaviors over extended periods of time.

In some examples, the source tracking data 130 may include information regarding an interaction between a first source of interest and a second source of interest within the video environment, such as proximity to other tracked sources of interest. For a particular source of interest such as a speaker, the source tracking data 130 may include synchronization information between visual and audio tracking information. In some examples, a confidence score may be provided for different aspects of tracking (e.g., position confidence, identity confidence, etc.). In some examples, the source tracking data 130 includes historical tracking information for a source of interest to enable analysis of patterns or behaviors over extended periods of time.

The source tracking model 110 may also synchronize data from multiple input sources that arrive at different rates or with different latencies. For instance, the video stream 103 may provide video frames at 30 frames per second while the audio stream 105 may provide audio samples at 48,000 samples per second. The source tracking model 110 may also utilize timestamp information from the metadata 304, the metadata 314, the metadata 326, and/or the metadata 336 to align data from different sources to a common time reference. The source tracking model 110 may also apply interpolation techniques to estimate values for input sources at time points where direct measurements are not available. Additionally, the source tracking model 110 may utilize buffering techniques to compensate for variable latencies in data arrival from different input sources.

The source tracking model 110 may also prioritize or weight different input sources when generating the source tracking data 130. For instance, the source tracking model 110 may assign higher weights to input sources that provide higher confidence scores, higher resolution data, and/or more recent measurements. The source tracking model 110 may dynamically adjust the weights based on real-time assessment of input quality and reliability. For example, if the video stream 103 becomes degraded due to low lighting conditions, the source tracking model 110 may increase the weight assigned to the audio stream 105 and/or the sensor data 107. The source tracking model 110 may also utilize learned weights from training data to optimize the contribution of each input source to the source tracking predictions.

In some examples, the source tracking model 110 may implement one or more fallback mechanisms when one or more input sources become unavailable or unreliable. For instance, if the video stream 103 is temporarily interrupted, the source tracking model 110 may continue to generate source tracking predictions based on the audio stream 105, the sensor data 107, and/or previously computed trajectory information. The source tracking model 110 may also maintain a degraded operation mode that utilizes a subset of available input sources while still providing useful source tracking functionality. The source tracking model 110 may also generate confidence scores that reflect the reduced reliability of predictions when operating with fewer input sources. Upon restoration of an unavailable input source, the source tracking model 110 may re-integrate the input source and adjust predictions accordingly.

The source tracking model 110 may also validate incoming data and/or assess data quality before processing. For instance, the source tracking model 110 may check for data integrity by verifying checksums, detecting corrupted frames, and/or identifying missing samples. The source tracking model 110 may also assess data quality by evaluating signal-to-noise ratios, detecting outliers, and/or comparing incoming data against expected ranges. Data that fails validation checks may be discarded, flagged for review, and/or replaced with interpolated values. The source tracking model 110 may also maintain quality metrics for each input source over time to identify persistent issues that may require attention.

The source tracking data 130 may also be provided back to a source to influence how input sources generate their data. For instance, the source tracking data 130 may be provided to the one or more DSP models 112 to adjust beamforming parameters, filter settings, and/or detection thresholds based on current tracking predictions. The source tracking data 130 may also be provided to the one or more AI models 114 to focus processing on regions of interest and/or to adjust model parameters based on tracking results. Additionally, the source tracking data 130 may be provided to the one or more video capture devices 102 to adjust camera parameters such as pan, tilt, zoom, and/or exposure based on the locations of tracked sources of interest. This feedback loop may enable the system 300 to adaptively optimize data capture and processing based on real-time tracking results.

In some examples, the system 300 may be configured to handle varying numbers of input sources and/or varying data rates. For instance, the source tracking model 110 may dynamically adapt to the addition or removal of video capture devices 102, audio capture devices 104, and/or sensors 106 without requiring reconfiguration. The source tracking model 110 may also adapt to changes in data rates such as when a video capture device 102 switches between different frame rate modes. The system 300 may utilize modular processing pipelines that scale with the number of active input sources. Additionally, the system 300 may implement load balancing techniques to distribute processing across available computational resources when the number of input sources or data rates increase.

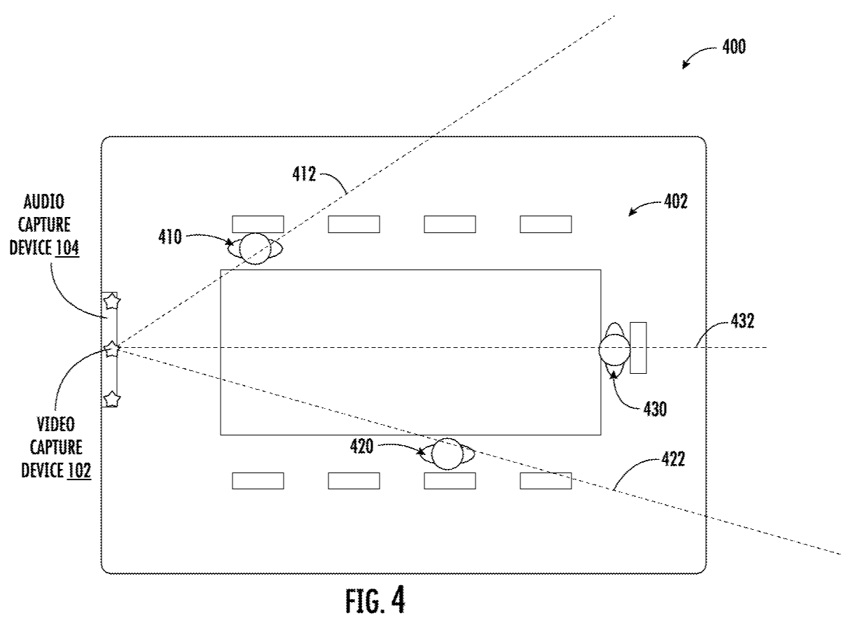

FIG. 4 illustrates an example video environment 400 according to one or more embodiments of the present disclosure. The video environment 400 may be an indoor environment, an outdoor environment, a room, a lecture hall, a performance hall, an auditorium, a broadcasting environment, a sports stadium or arena, a virtual environment, or another type of video environment. For example, the video environment 400 may be a conference room associated with a video conferencing setup. The video environment 400 includes video capture device 102 and audio capture device 104. In some examples, the video capture device 102 is a video camera and the audio capture device 104 is a microphone array. The video capture device 102 may be capable of capturing video (e.g., the video stream 103) from one or more sources of interest in the video environment 400. Additionally, the audio capture device 104 may be capable of capturing audio (e.g., the audio stream 105) from one or more sources of interest in the video environment 400. For example, the video environment 400 may include a source of interest 410, a source of interest 420, and/or a source of interest 430 located in a region of interest 402 of the video environment 400.

In some examples, the video capture device 102 and/or the audio capture device 104 may capture content 412 such as video content and/or audio content associated with the source of interest 410, content 422 such as video content and/or audio content associated with the source of interest 420, and content 432 such as video content and/or audio content associated with the source of interest 430. Additionally, DoA data based on audio associated with the content 412, the content 422, and/or the content 432 may be utilized to determine a location of the source of interest 410, the source of interest 420, and/or the source of interest 430 within the video environment 400. As such, video captured by the video capture device 102 may focus on the source of interest 410, the source of interest 420, and/or the source of interest 430 based on the DoA data from the audio capture device 104.

The AV processing system 108, the video capture device 102 and/or the audio capture device 104 may be communicatively coupled via a network. The network may include one or more network devices such as one or more network switches and/or one or more network routers. In some examples, the AV processing system 108 may provide video and/or audio from the video capture device 102 and/or the audio capture device 104 to a user device. In some examples, the user device may be configured as a host device for a video conference. The user device may be a smartphone, a laptop, a personal computer, a digital conference device, a wireless conference unit, an augmented reality device, a virtual reality device, or another type of user device. In some examples, the user device includes a display and/or a graphical user interface that renders video content provided by the video capture device 102. In some examples, the user device may provide a virtual video capture device and/or a virtual audio capture device a network system.

In some examples, the AV processing system 108, the video capture device 102 and/or the audio capture device 104 may be communicatively coupled via a network. The network may include one or more network devices such as one or more network switches and/or one or more network routers. In some examples, the AV processing system 108 may provide video and/or audio from the video capture device 102 and/or the audio capture device 104 to a user device. In some examples, the user device may be configured as a host device for a video conference. The user device may be a smartphone, a laptop, a personal computer, a digital conference device, a wireless conference unit, an augmented reality device, a virtual reality device, or another type of user device. In some examples, the user device includes a display and/or a graphical user interface that renders video content provided by the video capture device

The video environment 400 may be utilized for various conference room scenarios such as team meetings, executive presentations, client consultations, and/or multi-party discussions. The AV processing system 108 may also be configured to adapt capture behavior based on the type of meeting or event occurring within the video environment 400. For instance, during a presentation scenario, the AV processing system 108 may prioritize capture of a presenter at a designated presentation area while maintaining secondary capture of audience participants. During a collaborative discussion scenario, the AV processing system 108 may distribute capture focus among multiple participants seated around the table structure shown in FIG. 4.

The AV processing system 108 may also utilize beamforming techniques to spatially separate audio from the source of interest 410 and the source of interest 430 based on their respective positions within the region of interest 402. In some examples, the AV processing system 108 may utilize the spatial arrangement of sources of interest around the table structure in the video environment 400 to optimize tracking and capture strategies. For instance, the AV processing system 108 may utilize known or estimated seating positions to improve accuracy of audio localization and to reduce ambiguity in associating audio with visual detections. The AV processing system 108 may also utilize the table structure as a reference point for calibrating spatial coordinates within the video environment 400. Additionally, the AV processing system 108 may adjust beamforming parameters based on the spatial distribution of sources of interest to optimize audio capture for the particular seating arrangement.

The AV processing system 108 may also determine which source of interest to prioritize when multiple sources of interest are active within the video environment 400. For instance, the AV processing system 108 may utilize active speaker detection to identify which source of interest is currently speaking and may adjust video framing and audio capture to focus on the active speaker. The AV processing system 108 may also utilize priority rules based on factors such as speaking duration, speaking volume, visual gestures, and/or predefined roles assigned to sources of interest. For instance, a meeting organizer or presenter may be assigned a higher priority than other participants. The AV processing system 108 may also utilize smooth transitions when switching focus between sources of interest to avoid abrupt changes in video framing or audio levels.

The AV processing system 108 may also integrate DoA data from the audio capture device 104 with visual detection data from the video capture device 102 to improve tracking accuracy within the video environment 400. For instance, the AV processing system 108 may correlate an angle of arrival estimate from the audio capture device 104 with a bounding box detection from the video capture device 102 to confirm the identity and location of an active speaker. The AV processing system 108 may also utilize the combined audio and video data to resolve ambiguities that may arise when sources of interest are in close proximity, such as when the source of interest 410 and the source of interest 420 are seated adjacent to each other. The integration of audio and video data may enable the AV processing system 108 to maintain accurate tracking even when one modality provides limited information due to occlusion, noise, or other environmental factors.

In some examples, the AV processing system 108 may dynamically adjust the region of interest 402 based on meeting dynamics within the video environment 400. For instance, the region of interest 402 may expand to encompass additional seating positions when new participants join the meeting or contract when participants leave the meeting. The AV processing system 108 may also adjust the region of interest 402 based on the activity level within different areas of the video environment 400. For example, if the source of interest 420 becomes inactive for an extended period, the AV processing system 108 may temporarily exclude the area associated with the source of interest 420 from the region of interest 402 to optimize processing resources. The AV processing system 108 may also support multiple regions of interest within the video environment 400 to enable simultaneous capture of a presenter area and an audience area.

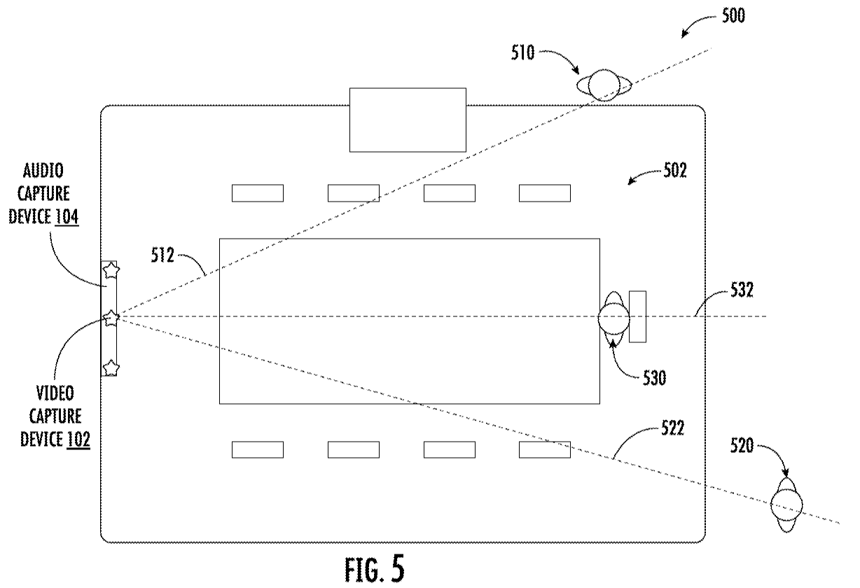

FIG. 5 illustrates an example video environment 500 according to one or more embodiments of the present disclosure. The video environment 500 may be an indoor environment, an outdoor environment, a room, a lecture hall, a performance hall, an auditorium, a broadcasting environment, a sports stadium or arena, a virtual environment, or another type of video environment. For example, the video environment 500 may be a conference room associated with a video conferencing setup. The video environment 500 includes video capture device 102 and audio capture device 104. In some examples, the video capture device 102 is a video camera and the audio capture device 104 is a microphone array.

The video capture device 102 may be capable of capturing video (e.g., the video stream 103) from one or more sources of interest in the video environment 500. Additionally, the audio capture device 104 may be capable of capturing audio (e.g., the audio stream 105) from one or more sources of interest in the video environment 500. For example, the video environment 500 may include a source of interest 510, a source of interest 520, and/or a source of interest 530. The source of interest 530 may be located in a region of interest 502 of the video environment 500. However, the source of interest 510 and the source of interest 520 may be located outside the region of interest 502.

In some examples, the video capture device 102 and/or the audio capture device 104 may capture content 532 such as video content and/or audio content associated with the source of interest 530. Additionally, content 512 (e.g., video content and/or audio content) associated with the source of interest 510 and content 522 (e.g., video content and/or audio content) associated with the source of interest 520 may be withheld from capture by the video capture device 102 and/or the audio capture device 104. In some examples, the AV processing system 108 may determine that the source of interest 510 and the source of interest 520 are outside of the region of interest 502 and may provide feedback to the video capture device 102 and/or the audio capture device 104 to actively withhold capture of audio and/or video associated with source of interest 510 and the source of interest 520.

The AV processing system 108 may also actively exclude the content 512 associated with the source of interest 510 and the content 522 associated with the source of interest 520 from capture and/or processing. The exclusion may involve preventing the content 512 and the content 522 from being included in output video streams, output audio streams, and/or source tracking operations. The AV processing system 108 may utilize the source tracking data 130 to continuously monitor the positions of the source of interest 510 and the source of interest 520 relative to the region of interest 502 and to maintain exclusion of the content 512 and the content 522 while these sources of interest remain outside the region of interest 502.

The AV processing system 108 may also detect when the source of interest 510 or the source of interest 520 transitions from outside the region of interest 502 into the region of interest 502. In response to detecting such a transition, the AV processing system 108 may enable audio capture and/or video capture for the transitioning source of interest and may begin including the associated content in output streams. Conversely, the AV processing system 108 may detect when the source of interest 530 transitions from within the region of interest 502 to outside the region of interest 502. In response to detecting such a transition, the AV processing system 108 may disable or filter audio capture and/or video capture for the source of interest 530. The AV processing system 108 may apply transition effects to provide smooth transitions as sources of interest move into or out of the region of interest 502.

The AV processing system 108 may also utilize audio-specific exclusion techniques to prevent capture of audio from the source of interest 510 and the source of interest 520. For instance, the AV processing system 108 may utilize beamforming to focus audio capture on the region of interest 502 while attenuating audio from directions associated with the source of interest 510 and the source of interest 520. The AV processing system 108 may also utilize null steering to steer nulls in the beamforming pattern toward the source of interest 510 and the source of interest 520, thereby suppressing audio from these sources while maintaining capture from the source of interest 530 within the region of interest 502. Additionally, the AV processing system 108 may utilize voice activity detection to identify and suppress speech from sources of interest outside the region of interest 502.

In some examples, the AV processing system 108 may utilize video-specific exclusion techniques to prevent capture of video content from the source of interest 510 and the source of interest 520. For instance, the AV processing system 108 may apply blurring, pixelation, and/or masking to portions of video frames that contain the source of interest 510 and the source of interest 520. The AV processing system 108 may also crop video frames to exclude areas outside the region of interest 502 from the output video stream. In some examples, the AV processing system 108 may utilize object detection to identify the source of interest 510 and the source of interest 520 in video frames and may selectively remove or obscure these sources of interest while preserving the remainder of the video content.

The AV processing system 108 may also dynamically adjust the region of interest 502 based on activity within the video environment 500. For instance, if the source of interest 510 or the source of interest 520 begins actively participating in a meeting or event, the AV processing system 108 may expand the region of interest 502 to include the newly active source of interest. Conversely, if the source of interest 530 becomes inactive for an extended period, the AV processing system 108 may contract the region of interest 502 or redefine the region of interest 502 to focus on other active sources of interest. The AV processing system 108 may also support user-initiated adjustments to the region of interest 502 via a user interface or an API.

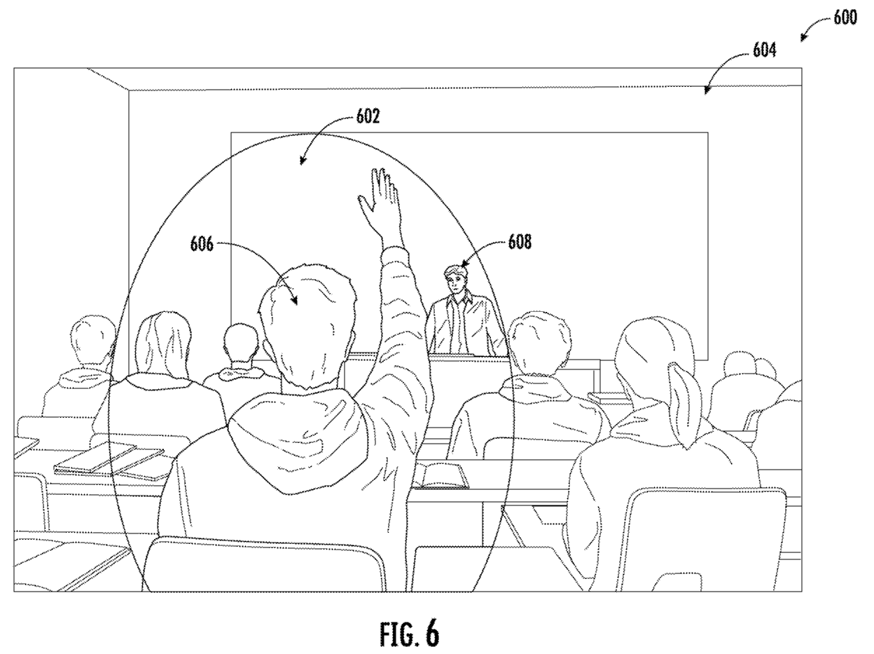

FIG. 6 illustrates an example video environment 600 according to one or more embodiments of the present disclosure. In some examples, the video environment 600 may correspond to or be similar to the video environment 400 and/or the video environment 500. The video environment 600 includes a region of interest 602 and an exclusion region 604. The region of interest 602 may represent an area of the video environment 600 where audio capture and/or video capture is permitted. The exclusion region 604 may represents an area the video environment 600 where audio capture and/or video capture is disabled or filtered by the AV processing system 108.

The region of interest 602 may be associated with dynamic fencing where the AV processing system 108 determine the region of interest 602 based on an action or gesture identified in a video stream (e.g., the video stream 103) associated with the video environment 600. For example, an action or gesture such as a raised hand by a source of interest 606 may trigger opening the region of interest 602 for audio and/or video content. In some examples, the region of interest 602 may be triggered in response to another action associated with another source of interest 608 (e.g., a pointing of a finger towards the source of interest 606) in the video environment 600.

Accordingly, sophisticated dynamic audio-video tracking and fencing may be provided. The dynamic fencing associated with the video environment 600 may also demonstrates the ability of the AV processing system 108 to adapt in real-time to changing conditions and/or user interactions within a video environment. For example, the region of interest 602 and the exclusion region 604 may illustrate the capability of the AV processing system 108 to selectively focus on specific areas while actively excluding others. This selective focus is especially beneficial for video environments where not all audio and video content are equally relevant or desired. For instance, in a conference room setting, the dynamic fencing may be utilized to focus on active speakers while minimizing background noise or visual distractions. By enabling the AV processing system 108 to adjust the region of interest 602 based on identified actions, gestures, or other non-verbal cues, capture of relevant content may be further enhanced without constant manual interactions with a video camera and/or microphone.

In some examples, the AV processing system 108 may dynamically adjust a boundary between the region of interest 602 and the exclusion region 604 based on real-time activity within the video environment 600. For instance, the boundary may expand to encompass additional sources of interest that become active or contract when sources of interest become inactive. The AV processing system 108 may utilize the source tracking data 130 to determine when to adjust the boundary and may apply smoothing techniques to improve transitions in the captured audio and/or video content.

The AV processing system 108 may also simultaneously track multiple sources of interest within the region of interest 602. For instance, the region of interest 602 may encompass both the source of interest 606 and the source of interest 608 to enable capture of an interaction between the two sources of interest. The AV processing system 108 may utilize the source tracking model 110 to maintain separate tracking information for each source of interest while also capturing the spatial relationship between the sources of interest. This enables scenarios where the source of interest 606 (e.g., a student) asks a question and the source of interest 608 (e.g., an instructor) provides a response, with both participants captured within the region of interest 602.

In some examples, the video environment 600 may be an educational environment such as a classroom, lecture hall, or training facility. The AV processing system 108 may be configured to track student participation by detecting raised hands, verbal contributions, and/or other indicators of engagement. The AV processing system 108 may prioritize capture of active participants while maintaining privacy for students in the exclusion region 604 who are not actively participating. For instance, students in the exclusion region 604 may have their faces blurred or their audio muted to protect their privacy while still enabling capture of the overall classroom environment.

The AV processing system 108 may detect when a source of interest transitions from the exclusion region 604 into the region of interest 602 or from the region of interest 602 into the exclusion region 604. In response to detecting a transition into the region of interest 602, the AV processing system 108 may enable audio capture and/or video capture for the transitioning source of interest and may add the source of interest to the identity object list. In response to detecting a transition into the exclusion region 604, the AV processing system 108 may disable or filter audio capture and/or video capture for the transitioning source of interest. The AV processing system 108 may apply transition effects such as fade-in or fade-out to provide smooth visual transitions as sources of interest move between regions.

The AV processing system 108 may also apply specific filtering techniques to content associated with the exclusion region 604. For video content, the AV processing system 108 may apply blurring, pixelation, silhouette rendering, and/or complete removal of visual content associated with sources of interest in the exclusion region 604. For audio content, the AV processing system 108 may apply muting, volume attenuation, active noise cancellation, and/or spectral filtering to suppress audio from sources of interest in the exclusion region 604. The AV processing system 108 may also apply class-specific filtering to selectively remove certain types of content from the exclusion region 604 while preserving other types of content.

The AV processing system 108 may also recognize a variety of gestures and/or actions to trigger determination or adjustment of the region of interest 602. For instance, in addition to a raised hand, the AV processing system 108 may recognize gestures such as a pointing gesture, a waving gesture, a thumbs-up gesture, a standing motion, an approach toward a presentation area, and/or other gestures that indicate a desire to participate or contribute. The AV processing system 108 may also recognize verbal cues such as a speaker addressing another person by name to trigger adjustment of the region of interest 602 to include the addressed person. The AV processing system 108 may be configured with a set of predefined gestures and/or actions, and the set of predefined gestures and/or actions may be customizable by a user via a user interface or an API.

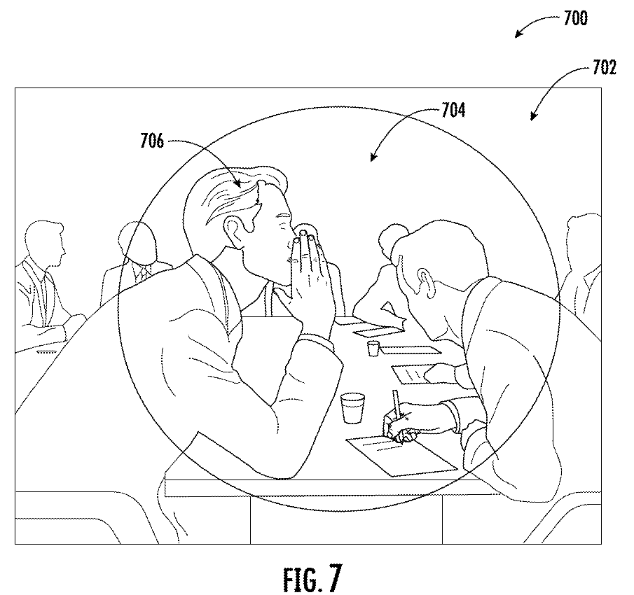

FIG. 7 illustrates an example video environment 700 according to one or more embodiments of the present disclosure. In some examples, the video environment 700 may correspond to or be similar to the video environment 400 and/or the video environment 500. The video environment 700 includes a region of interest 702 and an exclusion region 704. The region of interest 702 may represent an area of the video environment 700 where audio capture and/or video capture is permitted. The exclusion region 704 may represents an area the video environment 700 where audio capture and/or video capture is disabled or filtered by the AV processing system 108.

The exclusion region 704 may be associated with dynamic fencing where the AV processing system 108 determine the exclusion region 704 based on an action or gesture identified in a video stream (e.g., the video stream 103) associated with the video environment 700. For example, an action or gesture such as a whispering gesture by a source of interest 706 may trigger generation of the exclusion region 704 to disable capture of audio and/or video content in the exclusion region 704.

Accordingly, sophisticated dynamic audio-video tracking and fencing may be provided. The dynamic fencing associated with the video environment 700 may also demonstrate the ability of the AV processing system 108 to adapt in real-time to changing conditions and/or user interactions within a video environment. For example, the region of interest 702 and the exclusion region 704 may illustrate the capability of the AV processing system 108 to selectively focus on specific areas while actively excluding others. This selective exclusion of an area within the video environment 700 is especially beneficial for video environments where certain audio and/or video content are not desirable. For instance, in a conference room setting, the dynamic fencing may be utilized to disable audio and/or video capture related to certain active speakers where privacy of the source of interest 706 is desirable. By enabling the AV processing system 108 to create the exclusion region 704 based on identified actions, gestures, or other non-verbal cues, exclusion of certain content may be further enhanced without constant manual interactions with a video camera and/or microphone.

In some examples, the AV processing system 108 may generate the exclusion region 704 in response to detecting an exclusion-indicating action by the source of interest 706. Exclusion -indicating actions may include, for example, a whispering gesture, a hand-over-mouth gesture, a turning away from the video capture device, a huddle formation between multiple sources of interest, and/or other actions that indicate a desire for exclusion of audio or video capture. The AV processing system 108 may utilize the one or more AI models 114 to recognize these exclusion-indicating actions and may automatically generate the exclusion region 704 around the source of interest 706 without involving manual configuration. The AV processing system 108 may also be configured with predefined rules or policies that automatically trigger generation of the exclusion region 704 based on detected activities, recognized individuals, and/or contextual information associated with the video environment 700.

The exclusion region 704 may persist for a configurable duration after the triggering gesture or action is no longer detected. For instance, the AV processing system 108 may maintain the exclusion region 704 for a predefined timeout period such as 5 seconds, 10 seconds, or another configurable duration after the source of interest 706 completes the whispering gesture. The AV processing system 108 may also detect a dismissal gesture or action that explicitly terminates the exclusion region 704 before the timeout period expires. In some examples, the exclusion region 704 may persist until the source of interest 706 resumes normal activity such as facing the video capture device or speaking at a normal volume.

The AV processing system 108 may also apply audio-specific exclusion techniques to suppress audio capture within the exclusion region 704. For instance, the AV processing system 108 may utilize directional muting to attenuate audio signals arriving from the direction of the source of interest 706. The AV processing system 108 may also utilize beam nulling to steer a null in the beamforming pattern of a microphone array toward the exclusion region 704, thereby suppressing audio from that direction while maintaining capture from other directions. The AV processing system 108 may further utilize voice activity detection to identify and suppress speech from the source of interest 706 while preserving ambient audio from other areas of the video environment 700.

The AV processing system 108 may also support multiple simultaneous exclusion regions within the video environment 700. For instance, a first source of interest may trigger a first exclusion region while a second source of interest triggers a second exclusion region. The AV processing system 108 may maintain separate exclusion regions with independent boundaries, timeout periods, and filtering parameters. The AV processing system 108 may also merge overlapping exclusion regions into a single combined exclusion region when multiple sources of interest are in close proximity.

In some examples, the AV processing system 108 may determine a size and/or shape of the exclusion region 704 based on the detected gesture, the context of the video environment 700, and/or characteristics of the source of interest 706. For instance, the exclusion region 704 may be sized to encompass the source of interest 706 and a buffer zone around the source of interest 706. The AV processing system 108 may adjust the size of the exclusion region 704 based on the type of exclusion-indicating action detected. For example, a whispering gesture may generate a smaller exclusion region than a huddle formation involving multiple sources of interest. The shape of the exclusion region 704 may be circular, elliptical, rectangular, or another geometric shape based on the spatial arrangement of sources of interest within the exclusion region 704.

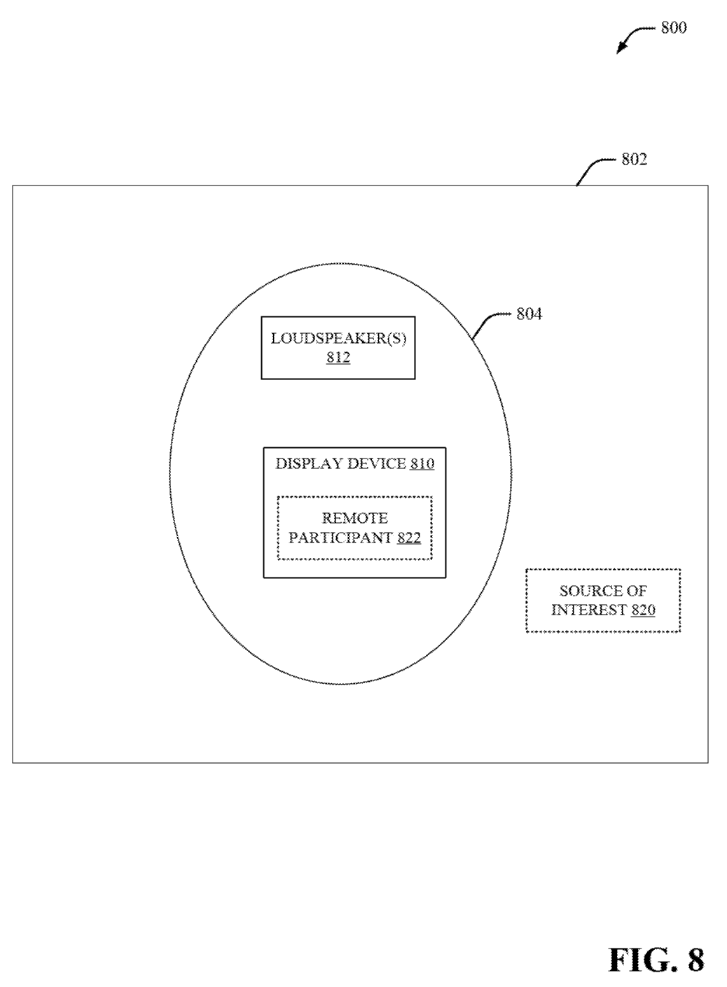

FIG. 8 illustrates an example video environment 800 according to one or more embodiments of the present disclosure. In some examples, the video environment 800 may correspond to or be similar to the video environment 400, the video environment 500, the video environment 600, and/or the video environment 700. The video environment 800 includes a region of interest 802 and an exclusion region 804. The region of interest 802 may represent an area of the video environment 800 where audio capture and/or video capture is enabled or prioritized. The exclusion region 804 may represent an area of the video environment 800 where audio capture and/or video capture is disabled or filtered by the AV processing system 108.

The video environment 800 includes a display device 810 and one or more loudspeakers 812 positioned within the video environment 800. The display device 810 may be a television, a monitor, a projection screen, and/or another type of display device configured to render visual content. The one or more loudspeakers 812 may be ceiling-mounted loudspeakers, wall-mounted loudspeakers, freestanding loudspeakers, and/or another type of audio output device configured to reproduce audio content within the video environment 800. The video environment 800 also includes a source of interest 820 physically present within the video environment 800 and a remote participant 822 visible on the display device 810.

The AV processing system 108 may generate the exclusion region 804 to encompass the display device 810 and/or the one or more loudspeakers 812. The environment fencing engine 122 may distinguish between the source of interest 820 physically present in the video environment 800 and the remote participant 822 visible on the display device 810. For instance, the environment fencing engine 122 may utilize the one or more AI models 114 to detect the display device 810 within the video environment 800 and may automatically generate the exclusion region 804 corresponding to the display device 810. This enables the AV processing system 108 to focus capture on the source of interest 820 within the region of interest 802 while excluding reproduced video content of the remote participant 822 from the display device 810.

The environment fencing engine 122 may also distinguish between audio from the source of interest 820 and audio reproduced by the one or more loudspeakers 812. For instance, the environment fencing engine 122 may identify locations of the one or more loudspeakers 812 based on known room configurations, the sensor data 107, and/or acoustic analysis of the audio stream 105. The environment fencing engine 122 may generate the exclusion region 804 to encompass the one or more loudspeakers 812 to prevent capture of reproduced audio. The AV processing system 108 may utilize beamforming techniques to steer nulls toward the one or more loudspeakers 812 while maintaining capture from the source of interest 820 within the region of interest 802.

The environment fencing engine 122 may utilize spatial information to distinguish between the one or more loudspeakers 812 and the source of interest 820 based on vertical position within the video environment 800. For instance, the environment fencing engine 122 may determine that audio sources located at ceiling height or along walls of the video environment 800 correspond to the one or more loudspeakers 812 rather than a physically present source of interest. The environment fencing engine 122 may utilize depth information from the sensor data 107, the video stream 103, and/or the audio stream 105 to estimate vertical positions of audio sources within the video environment 800. Based on the estimated positions, the environment fencing engine 122 may selectively exclude audio from the one or more loudspeakers 812 while preserving audio from the source of interest 820.

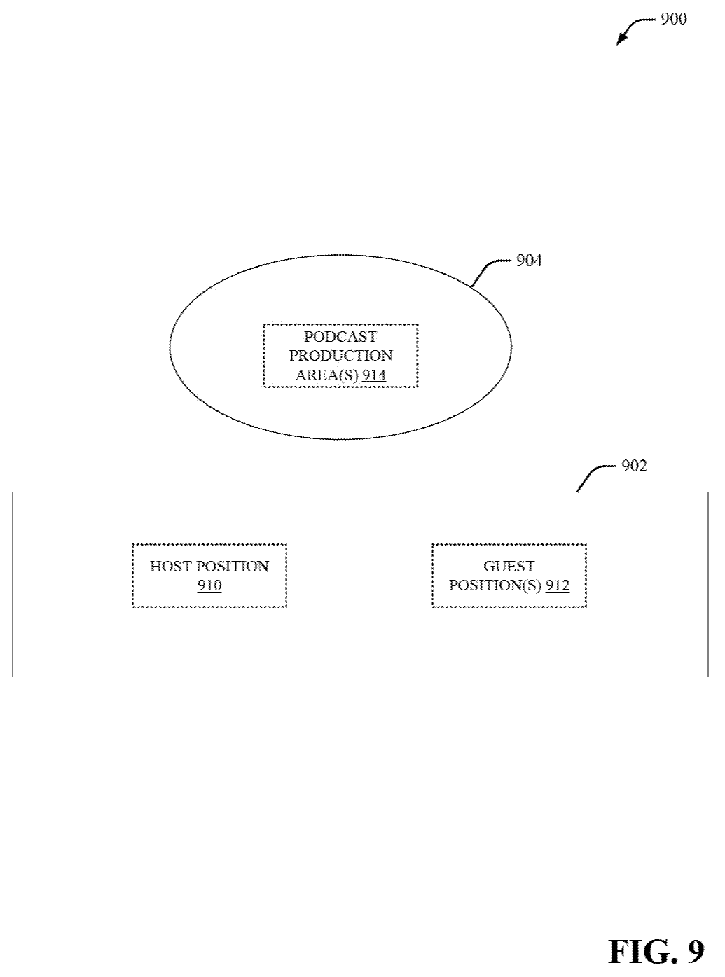

FIG. 9 illustrates an example video environment 900 according to one or more embodiments of the present disclosure. The video environment 900 may correspond to or be similar to the video environment 400, the video environment 500, the video environment 600, the video environment 700, and/or the video environment 800. The video environment 900 may be configured for podcast production. The video environment 900 includes a region of interest 902 and an exclusion region 904. The region of interest 902 may represent an area of the video environment 900 where audio capture and/or video capture is enabled or prioritized. The exclusion region 904 may represent an area of the video environment 900 where audio capture and/or video capture is disabled or filtered by the AV processing system 108.

The video environment 900 includes a host position 910 and one or more guest positions 912 within the region of interest 902. The host position 910 may correspond to a seating or standing location designated for a podcast host. The one or more guest positions 912 may correspond to seating or standing locations designated for one or more podcast guests. The video environment 900 also includes podcast production areas 914 within the exclusion region 904. The podcast production areas 914 may include production equipment (e.g., audio mixing equipment, recording devices, monitors, and/or other production hardware) and/or production crew members.

The AV processing system 108 may be configured with tracking, fencing, and capture functionality for podcast recording within the video environment 900. For instance, the AV processing system 108 may utilize predefined podcast configurations that specify the region of interest 902 to correspond to the host position 910 and the one or more guest positions 912, and the exclusion region 904 to correspond to the podcast production areas 914 within the video environment 900.

The AV processing system 108 may utilize podcast-specific mixing protocols to optimize audio capture within the video environment 900. For instance, the AV processing system 108 may automatically adjust beamforming parameters to focus on a speaker at the host position 910 or the one or more guest positions 912 based on active speaker detection. The AV processing system 108 may also apply noise reduction to minimize background sounds from the exclusion region 904 and balance audio levels between participants at the host position 910 and the one or more guest positions 912. The AV processing system 108 may utilize the source tracking data 130 to enable automatic camera switching between podcast participants at the host position 910 and the one or more guest positions 912 based on speaking activity.

The AV processing system 108 may also utilize the one or more AI models 114 to recognize podcast-specific activities within the video environment 900 such as microphone adjustments, script reading, and/or conversational turn-taking. The AV processing system 108 may dynamically adjust tracking and fencing parameters for the region of interest 902 and the exclusion region 904 based on the recognized activities. Additionally, the AV processing system 108 may support integration with podcast production software and/or hardware to enable synchronized capture and mixing of audio and video content from the video environment 900 for podcast distribution.

The AV processing system 108 may also dynamically adjust the region of interest 902 and/or the exclusion region 904 based on real-time activity within the video environment 900. As such, the region of interest 902 and/or the exclusion region 904 may be dynamically adjusted based on the recognized activities. For instance, the exclusion region 904 may be dynamically adjusted to additionally include the host position 910 or the one or more guest positions 912. As an example, if a guest arrives at one of the one or more guest positions 912 during a recording session, the AV processing system 108 may expand the region of interest 902 to include the newly occupied guest position. Conversely, if a guest departs from one of the one or more guest positions 912, the AV processing system 108 may contract the region of interest 902 accordingly. The AV processing system 108 may also adjust the exclusion region 904 to accommodate changes in production equipment placement or crew positioning during the recording session.

The term “artificial intelligence model,” “AI model,” “machine learning model,” and “ML model” refer to computational systems that implement machine learning or deep learning algorithms. The term “artificial intelligence” or “AI” refers broadly to computer systems designed to perform tasks that typically require human intelligence, including but not limited to reasoning, learning, problem-solving, perception, and natural language understanding. The term “machine learning” refers to a subset of artificial intelligence encompassing methods and algorithms that enable computer systems to learn patterns from data and make predictions or decisions without being explicitly programmed with rules for each specific scenario. Machine learning models are computer-implemented algorithms that may learn from data stored in databases or datastores, with or without relying on rules-based programming. These models enable reliable, repeatable decisions and results and facilitate the uncovering of hidden insights through machine-based learning from historical relationships and trends in the data.

Machine learning encompasses two primary learning paradigms: supervised learning and unsupervised learning. In supervised learning, a model is trained on a labeled dataset where each input example is paired with a corresponding target output or label. The model learns to map inputs to outputs by minimizing the difference between its predictions and the known labels. Examples of supervised learning tasks include classification (e.g., categorizing data into discrete classes such as spam detection, image recognition, or sentiment classification) and regression (e.g., predicting continuous values such as prices, temperatures, or durations).

Common supervised learning algorithms include linear regression, logistic regression, support vector machines (SVMs), decision trees, random forests, gradient boosting machines (e.g., XGBoost, LightGBM, CatBoost), k-nearest neighbors (KNN), and neural networks. In unsupervised learning, a model is trained on unlabeled data and must discover patterns, structures, or relationships within the data without explicit guidance. Examples of unsupervised learning tasks include clustering (e.g., grouping similar data points together using algorithms such as k-means, hierarchical clustering, DBSCAN, or Gaussian mixture models), dimensionality reduction (e.g., reducing the number of features while preserving important information using techniques such as principal component analysis (PCA), t-SNE, or UMAP), and anomaly detection (e.g., identifying unusual patterns or outliers in data). Semi-supervised learning combines elements of both paradigms, using a small amount of labeled data alongside a larger amount of unlabeled data to improve model performance.

An AI model is initially fit or trained on a training dataset comprising a set of examples used to fit or adjust the parameters of the model. During training, the AI model processes input data, generates predictions or outputs, and compares these outputs against target values (in supervised learning) or optimization objectives (in unsupervised learning). Based on the result of this comparison and the specific learning algorithm being used, the parameters of the model are adjusted through optimization techniques such as gradient descent, stochastic gradient descent (SGD), Adam, RMSprop, or other optimization algorithms.

Training data may be stored in databases or datastores and accessed via one or more application programming interfaces. The training process typically involves iterating over the training data multiple times (epochs) until the model converges to a satisfactory level of performance. Model performance is evaluated using metrics appropriate to the task, such as accuracy, precision, recall, F1 score, area under the ROC curve (AUC-ROC), mean squared error (MSE), mean absolute error (MAE), or other evaluation metrics. The machine learning models as described herein may make use of multiple ML engines (e.g., for analysis, transformation, inference, and other needs). The system may train different ML models for different needs and different ML-based engines, generate new models based on gathered training data, and evaluate their performance against existing models.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

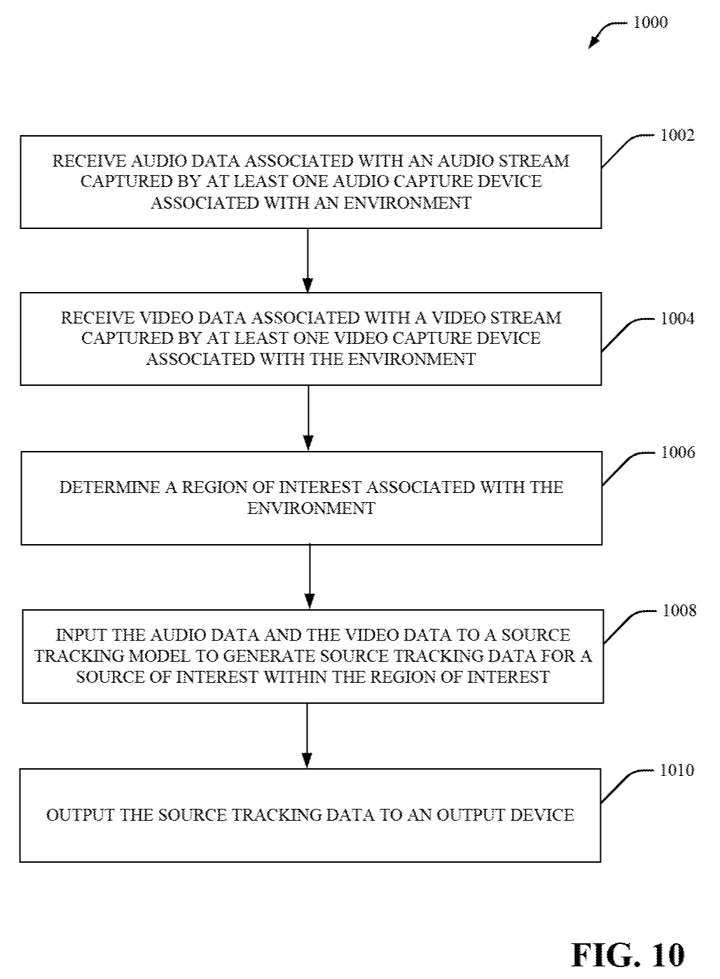

FIG. 10 is a flowchart diagram of an example process 1000 for providing dynamic audio-video tracking and/or fencing for video environments, in accordance with, for example, the AV processing apparatus 202 illustrated in FIG. 2. Via the various operations of the process 1000, the AV processing apparatus 202 may improve tracking and/or fencing of a source of interest within a video environment.

At block 1002, a processor (e.g., the processor 204 and/or the source tracking circuitry 208) receives audio data associated with an audio stream captured by at least one audio capture device associated with an environment. The audio data may include raw audio data, processed audio data, and/or audio metadata. In some examples, the audio data is provided by a digital signal processing model and/or an artificial intelligence model. In some examples, the audio metadata may include information associated with a detection event such as location or angle of arrival. In some examples, the audio metadata may include a voice classification and/or a noise classification provided by an AI model. In some examples, the audio metadata includes reverberation information (e.g., room reverberation information) associated with the environment.

At block 1004, a processor (e.g., the processor 204 and/or the source tracking circuitry 208) receives video data associated with a video stream captured by at least one video capture device associated with the environment. The video data may include raw video data, processed video data, and/or video metadata. In some examples, the video data is provided by a digital signal processing model and/or an artificial intelligence model.

At block 1006, a processor (e.g., the processor 204 and/or source tracking circuitry 208) determines a region of interest associated with the environment. In some examples, a processor (e.g., the processor 204 and/or source tracking circuitry 208) determines the region of interest based on user input provided via a user interface of a user device. For example, a user may interact with a user interface to draw a boundary around a specific area of a room such as a podium or presentation area. In another example, a user may utilize a user interface to select predefined zones within the video environment such as a conference table or whiteboard area. In some examples, a processor (e.g., the processor 204 and/or source tracking circuitry 208) determines the region of interest based on user input provided via an API. The API may enable a programmatic definition and/or manipulation for the region of interest. The API may further enable integration with one or more external systems and/or applications with respect to an AV processing system. In some examples, a processor (e.g., the processor 204 and/or source tracking circuitry 208) determines the region of interest based on independent analysis with respect to the video stream and the audio stream.

At block 1008, a processor (e.g., the processor 204 and/or source tracking circuitry 208) inputs the audio data and the video data to a source tracking model to generate source tracking data for a source of interest within the region of interest. The source tracking data may include tracking information for one or more source of interest in the video environment. In some examples, the source tracking data may include a unique identifier, a 3D position, a velocity vector, a confidence score, identify content, and/or associated metadata for respective tracked sources of interest. In some examples, the source tracking data may include temporal information such as timestamps for each tracked position to enable reconstruction of movement trajectories over time. In some examples, the source tracking data may include size or bounding box information for visual sources, audio characteristics such as frequency range or volume for audio sources, and/or predicted future positions based on current trajectories. In some examples, the source tracking data may include information regarding an interaction between a first source of interest and a second source of interest within the video environment, such as proximity to other tracked sources of interest. For a particular source of interest such as a speaker, the source tracking data may include synchronization information between visual and audio tracking information. In some examples, a confidence score may be provided for different aspects of tracking (e.g., position confidence, identity confidence, etc.). In some examples, the source tracking data includes historical tracking information for a source of interest to enable analysis of patterns or behaviors over extended periods of time.

At block 1010, a processor (e.g., the processor 204 and/or source tracking circuitry 208) outputs the source tracking data to an output device. The output device may include one or more of: a speaker, a speaker array, headphones, earphones, a video capture device (e.g., a camera), a codec (e.g., coder-decoder) device, an audio mixer device, a smartphone, a tablet computer, a laptop, a personal computer, an audio workstation device, a wearable device, an augmented reality device, a virtual reality device, a broadcasting device, a recording device, a haptic device, or another type of output device. In some examples, the output device is an output device communicatively coupled to a microphone array that captures the audio stream. In some examples, the source tracking data may be provided to the output device in combination with an indication of the region of interest, location information for the source of interest, and/or an identity object list for the environment.

Although the process 1000 depicts a particular sequence of blocks and/or operations, the sequence may be altered without departing from the scope of the present disclosure. For example, some of the blocks and/or operations depicted may be performed in parallel or in a different sequence that does not materially affect the function of the processes. Additionally, such blocks and/or operations may be performed in any of a number of ways, including, without limitation, in the order and manner as depicted and described herein. In some examples, the process 1000 includes some or all blocks and/or operations described and/or depicted. Similarly, it should be appreciated that one or more of the blocks and/or operations of the process 1000 may be combinable, replaceable, and/or otherwise altered as described herein

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, e.g., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, engine, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term "or" is used herein in both the alternative and conjunctive sense, unless otherwise indicated. The terms "illustrative," "example," and "exemplary" are used to be examples with no indication of quality level. Like numbers refer to like elements throughout.

The term "comprising" means "including but not limited to," and should be interpreted in the manner it is typically used in the patent context. Use of broader terms such as comprises, includes, and having should be understood to provide support for narrower terms, such as consisting of, consisting essentially of, comprised substantially of, and/or the like.

The phrases "in one embodiment," "according to one embodiment," and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the at least one processor, to cause the apparatus to: receive audio data associated with an audio stream captured by at least one audio capture device associated with an environment.

Clause 2. The apparatus of clause 1, wherein the instructions are further operable to cause the apparatus to: receive video data associated with a video stream captured by at least one video capture device associated with the environment.

Clause 3. The apparatus of any one of the foregoing clauses, wherein the instructions are further operable to cause the apparatus to: determine a region of interest associated with the environment.

Clause 4. The apparatus of any one of the foregoing clauses, wherein the instructions are further operable to cause the apparatus to: input the audio data and the video data to a source tracking model to generate source tracking data for a source of interest within the region of interest.

Clause 5. The apparatus of any one of the foregoing clauses, wherein the instructions are further operable to cause the apparatus to: output the source tracking data to an output device.

Clause 6. The apparatus of any one of the foregoing clauses, wherein the audio data is provided by a digital signal processing model.

Clause 7. The apparatus of any one of the foregoing clauses, wherein the audio data is provided by an artificial intelligence model.

Clause 8. The apparatus of any one of the foregoing clauses, wherein the audio data comprises raw audio data associated with the audio stream.

Clause 9. The apparatus of any one of the foregoing clauses, wherein the video data is provided by a digital signal processing model.

Clause 10. The apparatus of any one of the foregoing clauses, wherein the video data is provided by an artificial intelligence model.

Clause 11. The apparatus of any one of the foregoing clauses, wherein the video data comprises raw video data associated with the video stream.

Clause 12. The apparatus of any one of the foregoing clauses, wherein the instructions are further operable to cause the apparatus to: input (i) the audio data, (ii) the video data, and (iii) metadata associated with the at least one audio capture device to the source tracking model to generate the source tracking data.

Clause 13. The apparatus of any one of the foregoing clauses, wherein the instructions are further operable to cause the apparatus to: input (i) the audio data, (ii) the video data, and (iii) metadata associated with the at least one video capture device to the source tracking model to generate the source tracking data.

Clause 14. The apparatus of any one of the foregoing clauses, wherein the instructions are further operable to cause the apparatus to: input (i) the audio data, (ii) the video data, and (iii) metadata associated with at least one artificial intelligence model to the source tracking model to generate the source tracking data.

Clause 15. The apparatus of any one of the foregoing clauses, wherein the instructions are further operable to cause the apparatus to: input (i) the audio data, (ii) the video data, and (iii) sensor data associated with the environment to the source tracking model to generate the source tracking data.

Clause 16. The apparatus of any one of the foregoing clauses, wherein the instructions are further operable to cause the apparatus to: transmit the source tracking data and the region of interest to the at least one video capture device.

Clause 17. The apparatus of any one of the foregoing clauses, wherein the region of interest corresponds to a defined coverage area for the environment.

Clause 18. The apparatus of any one of the foregoing clauses, wherein the environment comprises at least a first area and a second area, and wherein the region of interest corresponds to the first area or the second area of the environment.

Clause 19. The apparatus of any one of the foregoing clauses, wherein the instructions are further operable to cause the apparatus to: determine the region of interest based at least in part on user input provided via a user interface of a user device

Clause 20. The apparatus of any one of the foregoing clauses, wherein the instructions are further operable to cause the apparatus to: determine the region of interest based at least in part on user input provided via an application programming interface.

Clause 21. The apparatus of any one of the foregoing clauses, wherein the instructions are further operable to cause the apparatus to: determine the region of interest based at least in part on an action or gesture identified in the video stream.

Clause 22. The apparatus of any one of the foregoing clauses, wherein the instructions are further operable to cause the apparatus to: determine location information for the source of interest based at least in part on the audio data.

Clause 23. The apparatus of any one of the foregoing clauses, wherein the instructions are further operable to cause the apparatus to: determine facial recognition information for the source of interest based at least in part on the video data.

Clause 24. The apparatus of any one of the foregoing clauses, wherein the instructions are further operable to cause the apparatus to: determine the region of interest based at least in part on the location information and the facial recognition information.

Clause 25. The apparatus of any one of the foregoing clauses, wherein the location information comprises direction of arrival information associated with the at least one audio capture device or position information associated with a position of the source of interest within the environment.

Clause 26. The apparatus of any one of the foregoing clauses, wherein the instructions are further operable to cause the apparatus to: determine the region of interest based at least in part on a keyword identified in the audio stream.

Clause 27. The apparatus of any one of the foregoing clauses, wherein the instructions are further operable to cause the apparatus to: determine the region of interest based at least in part on a first event associated with the video stream and a second event associated with the audio stream.

Clause 28. The apparatus of any one of the foregoing clauses, wherein the instructions are further operable to cause the apparatus to: determine location information for the source of interest based at least in part on the source tracking data.

Clause 29. The apparatus of any one of the foregoing clauses, wherein the instructions are further operable to cause the apparatus to: transmit the source tracking data and the location information to the at least one video capture device.

Clause 30. The apparatus of any one of the foregoing clauses, wherein the instructions are further operable to cause the apparatus to: transmit at least one of the source tracking data, the region of interest, and the location information to the at least one video capture device.

Clause 31. The apparatus of any one of the foregoing clauses, wherein the instructions are further operable to cause the apparatus to: manage an identity object list for the environment based at least in part on the source tracking data.

Clause 32. The apparatus of any one of the foregoing clauses, wherein the instructions are further operable to cause the apparatus to: transmit the source tracking data and the identity object list to the at least one video capture device.

Clause 33. The apparatus of any one of the foregoing clauses, wherein the instructions are further operable to cause the apparatus to: transmit the source tracking data, the region of interest, and the identity object list to the at least one video capture device.

Clause 34. The apparatus of any one of the foregoing clauses, wherein the output device is the at least one audio capture device, the at least one video capture device, or a processor that executes an artificial intelligence model.

Clause 35. The apparatus of any one of the foregoing clauses, wherein the instructions are further operable to cause the apparatus to: determine location information for the source of interest based at least in part on the source tracking data.

Clause 36. The apparatus of any one of the foregoing clauses, wherein the instructions are further operable to cause the apparatus to: manage an identity object list for the environment based at least in part on the source tracking data.

Clause 37. The apparatus of any one of the foregoing clauses, wherein the instructions are further operable to cause the apparatus to: transmit the source tracking data, the region of interest, the location information, and the identity object list to the at least one video capture device.

Clause 38. The apparatus of any one of the foregoing clauses, wherein the source tracking model is an artificial intelligence model.

Clause 39. The apparatus of any one of the foregoing clauses, wherein the source tracking model is a digital signal processing model.

Clause 40. The apparatus of any one of the foregoing clauses, wherein the instructions are further operable to cause the apparatus to: transmit the source tracking data to a camera control system of the at least one video capture device to enable control of the at least one video capture device based on the source tracking data.

Clause 41. The apparatus of any one of the foregoing clauses, wherein the control of the at least one video capture device enables modification of camera framing for the at least one video capture device.

Clause 42. The apparatus of any one of the foregoing clauses, wherein the instructions are further operable to cause the apparatus to: steer one or more beamformed lobes of a microphone array based at least in part on the source tracking data.

Clause 43. The apparatus of any one of the foregoing clauses, wherein the instructions are further operable to cause the apparatus to: apply active noise cancellation to one or more portions of the audio stream associated with a region of the environment that is different than the region of interest.

Clause 44. The apparatus of any one of the foregoing clauses, wherein the instructions are further operable to cause the apparatus to: disable video capture for one or more portions of the video stream associated with a region of the environment that is different than the region of interest.

Clause 45. The apparatus of any one of the foregoing clauses, wherein the instructions are further operable to cause the apparatus to: apply class-specific filtering to one or more portions of the audio stream associated with a region of the environment that is different than the region of interest.

Clause 46. The apparatus of any one of the foregoing clauses, wherein the instructions are further operable to cause the apparatus to: apply class-specific filtering to one or more portions of the video stream associated with a region of the environment that is different than the region of interest.

Clause 47. The apparatus of any one of the foregoing clauses, wherein the audio data comprises audio modeling data associated with a voice classification.

Clause 48. The apparatus of any one of the foregoing clauses, wherein the instructions are further operable to cause the apparatus to: determine whether or not to input a particular portion of the video data associated with the video stream to the source tracking model based on the audio modeling data.

Clause 49. The apparatus of any one of the foregoing clauses, wherein the audio data comprises audio modeling data associated with a noise classification.

Clause 50. The apparatus of any one of the foregoing clauses, wherein the instructions are further operable to cause the apparatus to: determine whether or not to input a particular portion of the video data associated with the video stream to the source tracking model based on the audio modeling data.

Clause 51. The apparatus of any one of the foregoing clauses, wherein the audio data comprises audio modeling data associated with a voice classification and a noise classification.

Clause 52. The apparatus of any one of the foregoing clauses, wherein the instructions are further operable to cause the apparatus to: determine whether or not to input a particular portion of the video data associated with the video stream to the source tracking model based on the audio modeling data.

Clause 53. The apparatus of any one of the foregoing clauses, wherein the audio data comprises audio modeling data associated with a noise classification.

Clause 54. The apparatus of any one of the foregoing clauses, wherein the instructions are further operable to cause the apparatus to: wherein the instructions are further operable to cause the apparatus to: configure the source tracking model based on known or estimated positions of devices within the video environment.

Clause 55. A computer-implemented method comprising steps in accordance with any one of the foregoing clauses

Clause 56. A computer program product, stored on a computer readable medium, comprising instructions that, when executed by one or more processors of the audio signal processing apparatus, cause the one or more processors to perform one or more operations related to any one of the foregoing clauses.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising at least one processor and a memory storing instructions that are operable, when executed by the at least one processor, to cause the apparatus to:
receive audio data associated with an audio stream captured by at least one audio capture device associated with an environment;
receive video data associated with a video stream captured by at least one video capture device associated with the environment;
determine a region of interest associated with the environment;
input the audio data and the video data to a source tracking model to generate source tracking data for a source of interest within the region of interest; and
output the source tracking data to an output device.

2. The apparatus of claim 1, wherein the instructions are further operable to cause the apparatus to:
input (i) the audio data, (ii) the video data, and (iii) metadata associated with the at least one audio capture device to the source tracking model to generate the source tracking data.

33 The apparatus of claim 1, wherein the instructions are further operable to cause the apparatus to:
input (i) the audio data, (ii) the video data, and (iii) metadata associated with the at least one video capture device to the source tracking model to generate the source tracking data.

4. The apparatus of claim 1, wherein the instructions are further operable to cause the apparatus to:
input (i) the audio data, (ii) the video data, and (iii) metadata associated with at least one artificial intelligence model to the source tracking model to generate the source tracking data.

5. The apparatus of claim 1, wherein the instructions are further operable to cause the apparatus to:
input (i) the audio data, (ii) the video data, and (iii) sensor data associated with the environment to the source tracking model to generate the source tracking data.

6. The apparatus of claim 1, wherein the instructions are further operable to cause the apparatus to:
transmit the source tracking data and the region of interest to the at least one video capture device.

7. The apparatus of claim 1, wherein the instructions are further operable to cause the apparatus to:
determine the region of interest based at least in part on user input provided via a user interface of a user device.

8. The apparatus of claim 1, wherein the instructions are further operable to cause the apparatus to:
determine the region of interest based at least in part on an action or gesture identified in the video stream.

9. The apparatus of claim 1, wherein the instructions are further operable to cause the apparatus to:
determine location information for the source of interest based at least in part on the audio data;
determine facial recognition information for the source of interest based at least in part on the video data; and
determine the region of interest based at least in part on the location information and the facial recognition information.

10. The apparatus of claim 1, wherein the instructions are further operable to cause the apparatus to:
determine the region of interest based at least in part on a keyword identified in the audio stream.

11. The apparatus of claim 1, wherein the instructions are further operable to cause the apparatus to:
determine the region of interest based at least in part on a first event associated with the video stream and a second event associated with the audio stream.

12. The apparatus of claim 1, wherein the instructions are further operable to cause the apparatus to:
determine location information for the source of interest based at least in part on the source tracking data; and
transmit at least one of the source tracking data, the region of interest, or the location information to the at least one video capture device.

13. The apparatus of claim 1, wherein the instructions are further operable to cause the apparatus to:
manage an identity object list for the environment based at least in part on the source tracking data; and
transmit at least one of the source tracking data, the region of interest, or the identity object list to the at least one video capture device.

14. The apparatus of claim 1, wherein the instructions are further operable to cause the apparatus to:
determine location information for the source of interest based at least in part on the source tracking data;
manage an identity object list for the environment based at least in part on the source tracking data; and
transmit the source tracking data, the region of interest, the location information, and the identity object list to the at least one video capture device.

15. The apparatus of claim 1, wherein the instructions are further operable to cause the apparatus to:
transmit the source tracking data to a camera control system of the at least one video capture device to enable control of the at least one video capture device based on the source tracking data.

16. The apparatus of claim 1, wherein the instructions are further operable to cause the apparatus to:
steer one or more beamformed lobes of a microphone array based at least in part on the source tracking data.

17. A computer-implemented method comprising:
receiving audio data associated with an audio stream captured by at least one audio capture device associated with an environment;
receiving video data associated with a video stream captured by at least one video capture device associated with the environment;
determining a region of interest associated with the environment;
inputting the audio data and the video data to a source tracking model to generate source tracking data for a source of interest within the region of interest; and
outputting the source tracking data to an output device.

18. The computer-implemented method of claim 17, further comprising:
inputting (i) the audio data, (ii) the video data, and (iii) metadata to the source tracking model to generate the source tracking data.

19. The computer-implemented method of claim 17, further comprising:
inputting (i) the audio data, (ii) the video data, and (iii) sensor data associated with the environment to the source tracking model to generate the source tracking data.

20. A computer program product, stored on a computer readable medium, comprising instructions that, when executed by one or more processors of an apparatus, cause the one or more processors to:
receive audio data associated with an audio stream captured by at least one audio capture device associated with an environment;
receive video data associated with a video stream captured by at least one video capture device associated with the environment;
determine a region of interest associated with the environment;
input the audio data and the video data to a source tracking model to generate source tracking data for a source of interest within the region of interest; and
output the source tracking data to an output device.
